(19) United States
(12) Patent Application Publication
(10) Pub. No.: US 2025/0075034 A1
(43) Pub. Date: Mar. 6, 2025

(54) Process for Preparing a Polyurea

(71) Applicant: University Court of the University of St Andrews, Fife (GB)

(72) Inventor: Amit KUMAR, Fife (GB)

(21) Appl. No.: 18/547,264

(22) PCT Filed: Feb. 22, 2022
(86) PCT No.: PCT/GB2022/050482

§ 371 Date: Aug. 21, 2023

(30) Foreign Application Priority Data
Feb. 22, 2021 (GB) 2102474.0
Sep. 7, 2021 (GB) 2112701.4

(51) Int. Cl. C08G 71/02

(52) U.S. Cl. CPC C08G 71/02

(57) ABSTRACT

A process for preparing a polyurea by dehydrogenative coupling of an amine compound amine compound containing at least two non-tertiary amino groups and methanol, comprising reacting the amine compound and methanol in the presence of a metal pincer catalyst and a base to form a polyurea and hydrogen gas.

### FIELD OF THE INVENTION

The invention relates to a process for the synthesis of a polyurea by the dehydrogenative coupling of a diamine or a polyamine and methanol using a metal (e.g. ruthenium) pincer catalyst. Advantageously, the process avoids the use of toxic diisocyanates, conventionally used in the production of polyurea. Further, the process for the synthesis of polyurea can be reversible; the polyurea so-formed can be converted back to the diamine or polyamine and methanol reagents by hydrogenation. Thus, the processes of the invention can contribute to a circular economy.

### BACKGROUND OF THE INVENTION

Polyureas are polymers with applications in coating, adhesive and biomedical materials. In particular, there is a demand for polyurea coatings, with their annual global market worth expected to rise from its current value of USD 885 million to USD 1481 million by 2025. Polyureas are conventionally produced from the reaction of diamines and diisocyanates. However, the conventional process is complicated by the fact that diisocyanates and their precursor (phosgene gas) are extremely toxic. There is a need to provide an alternative technology for the synthesis of polyureas that is safer and/or more environmentally friendly than the conventional process.

Two approaches in the direction of diisocyanate-free synthesis of polyureas have been reported. The first approach is based on the synthesis of polyureas from the polycondensation of diamines with CO₂ (Jiang, S. et al., Synthesis of Polyurea from 1,6-Hexanediamine with CO₂ through a Two-Step Polymerization. Green Energy Environ. 2017, 2 (4), 370-376). Although the use of CO₂ for the synthesis of polyureas is attractive, the use of harsh reaction conditions such as reaction temperature of 170-180° C., and CO₂ pressure of 40-110 bars, in order to overcome the strict thermodynamic barriers, present a bottleneck to the utilization of this methodology on an industrial level. Another approach is based on the polycondensation of diamines with CO₂ derivatives—organic carbamates (Kébir, N. et al., Non-Isocyanate Thermoplastic Polyureas (NIPUreas) through a Methyl Carbamate Metathesis Polymerization. Eur. Polym. J. 2017, 96, 87-96), organic carbonates (Soccio, M. et al., Urea and Polyurea Production: An Innovative Solvent- and Catalyst-Free Approach through Catechol Carbonate. ACS Sustain. Chem. Eng. 2020) and inorganic urea (NH₂CONH₂) (Dennis, J. M. et al., Synthesis and Characterization of Isocyanate-Free Polyureas. Green Chem. 2018, 20 (1), 243-249). This methodology also suffers from drawbacks such as the use of expensive reagents or solvents (e.g. biscarbamate or ionic liquids as solvent), poor substrate scope, and low atom-economy.

Ruthenium pincer catalysts have been used to synthesise urea derivatives and to hydrogenate urea derivatives. The synthesis of urea derivatives via reaction of amines and methanol in the presence of a ruthenium pincer catalyst is described by S. Kim and S. Hong in Org. Lett. 2016, 18, 212-215, and the use of pyridine-based ruthenium pincer complexes in the hydrogenation of urea derivatives to alcohols and amines is described in US 2017/0283447 (Yeda Research and Development Co. Ltd.).

It is an objective of the present invention to meet one or more of the needs or solve one or more of the problems described above.

### SUMMARY OF THE INVENTION

In a first aspect, the invention provides a process for preparing a polyurea by dehydrogenative coupling of an amine compound and methanol, comprising reacting an amine compound and methanol in the presence of a metal pincer complex and a base to form polyurea and hydrogen gas,

wherein the amine compound is of formula (I):

R¹HN—(CH₂)ₘ—W—(CH₂)ₙ—NHR² (I)

where each of R¹ and R² is independently H or a C1 to C4 hydrocarbyl group; and where:
(a) W is a C2 to C24 alkylene group, a substituted C2 to C24 alkylene group, a C2 to C24 heteroalkylene group or a substituted C2 to C24 heteroalkylene group, and each of m and n is 0, with the proviso that when both of R¹ and R² are H, W has at least 6 carbon atoms;
(b) W is a divalent fatty acid dimer radical and each of m and n is 0;
(c) W is a C5 to C13 cycloalkylene group, a substituted C5 to C13 cycloalkylene group, a C5 to C13 heterocycloalkylene group or a substituted C5 to C13 heterocycloalkylene group, and each of m and n is independently 0 or from 1 to 10;
(d) W is a group having the structure —R³-Q-R³—, where R³ is a C5 or C6 cycloalkylene group, a substituted C5 or C6 cycloalkylene group, a C5 or C6 heterocycloalkylene group or a substituted C5 or C6 heterocycloalkylene group, Q is —CH₂—, —CH(CH₃)—, —CH═CH—, —C(═CH₂)—, —O—, —N(H)—, —S—R⁴—S—, where R⁴ is a C5 heteroarylene group or phenylene, and each of m and n is independently 0 or 1;
(e) W is an arylene group, a substituted arylene group, a heteroarylene group or a substituted heteroarylene group, and each of m and n is independently 0 or from 1 to 10;
(f) W is a group having the structure —R⁵-Q-R⁵—, where R⁵ is an arylene group or a heteroarylene group, Q is —CH₂—, —CH(CH₃)—, —CH═CH—, —C(═CH₂)—, —O—, —N(H)—, —S—R⁴—S—, where R⁴ is a C5 heteroarylene group or phenylene, and each of m and n is independently 0 or from 1 to 10; or
(g) W is a group having the structure —N(R⁶)—, wherein R⁶ is —(CH₂)ₜ—NH₂, where t is 2 or 3, and each of m and n is independently 0 or from 1 to 10; and
where when m is from 1 to 10, up to 3 in every 10 carbon atoms in the —(CH₂)ₘ— group is a heteroatom and when n is from 1 to 10, up to 3 in every 10 carbon atoms in the —(CH₂)ₙ— group is a heteroatom; and
wherein the metal pincer catalyst is a metal-based complex having a tridentate pincer ligand and has the general formula (II):

MXYZ′L (II)
where M is Ru or Mn
where X is H or halo (such as Cl),
Y is H, halo, CO, or borohydride,
Z′ is CO or PPh₃ and
L is a tridentate ligand with ANB donor sites in a meridional geometry, where each of A and B is independently chosen from P, N, O, S and N-heterocyclic carbenes.

The invention is a new catalytic method for the synthesis of polyureas comprising dehydrogenative coupling of a diamine or a polyamine and methanol using a metal (e.g. ruthenium) pincer catalyst. The reaction is catalysed by a metal (e.g. ruthenium) pincer complex and liberates H₂ gas, which is valuable in itself, as the only by-product making the process highly atom economic. Advantageously, toxic diisocyanates are not utilised in the process, and thus the process is less toxic and safer for the environment and human health. Advantageously, the reactants (the amine compound and methanol) can be obtained from renewable sources, thus allowing for the synthesis of 100% renewable polyureas or bioplastic as 100% renewable methanol is commercially available (https://www.carbonrecycling.is/). Furthermore, the method can be used to produce ¹³C-labelled polyureas, which may have potential applications in the biomedical and materials industries.

In another aspect, the invention relates to a polyurea obtained/obtainable by the process of the first aspect, and, in particular, to a polyurea that is prepared from renewable reactants, and to a ¹³C-labelled polyurea (prepared using ¹³CH₃OH).

In further aspect, the invention provides a process for hydrogenative depolymerisation of a polyurea obtained/obtainable by the process of the first aspect, to produce an amine compound and methanol. Thus the polyurea can be converted back to the original reactants, i.e. the polyurea can be recycled.

### DETAILED DESCRIPTION OF THE INVENTION

The present invention is a process for preparing polyurea by dehydrogenative coupling of an amine compound and methanol using a metal (e.g. ruthenium) pincer catalyst. The invention is based, in part, on the recognition that catalytic dehydrogenation can be employed to synthesise polyurea from an amine compound and methanol, and the recognition that this method can make use of renewable reactants, and can be used to synthesize isotopically labelled polyurea.

Although the invention is frequently described herein with reference to ruthenium-based pincer complexes, which represent particular embodiments of the invention, it will be understood that the invention is not to be so construed unless the context expressly provides for this.

In a first aspect, the invention provides a process for preparing a polyurea by dehydrogenative coupling of an amine compound and methanol, comprising reacting the amine compound and methanol in the presence of a metal (e.g. ruthenium) pincer catalyst and a base to form polyurea and hydrogen gas as described above.

### Amine Compound

The amine compound employed in the process of the invention is a diamine or a polyamine. The amine compound contains at least two non-tertiary amino groups. The amine compound may contain no tertiary amino groups or may contain only one, i.e. a single, tertiary amino group.

The amine compound is according to formula (I):

R¹HN—(CH₂)ₘ—W—(CH₂)ₙ—NHR² (I)

where each of R¹ and R² is independently H or a C1 to C4 hydrocarbyl group; and where:
(a) W is a C2 to C24 alkylene group, a substituted C2 to C24 alkylene group, a C2 to C24 heteroalkylene group or a substituted C2 to C24 heteroalkylene group, and each of m and n is 0, with the proviso that when both of R¹ and R² are H, W has at least 6 carbon atoms;
(b) W is a divalent fatty acid dimer radical and each of m and n is 0;
(c) W is a C5 to C13 cycloalkylene group, a substituted C5 to C13 cycloalkylene group, a C5 to C13 heterocycloalkylene group or a substituted C5 to C13 heterocycloalkylene group, and each of m and n is independently 0 or from 1 to 10;
(d) W is a group having the structure —R³-Q-R³—, where R³ is a C5 or C6 cycloalkylene group, a substituted C5 or C6 cycloalkylene group, a C5 or C6 heterocycloalkylene group or a substituted C5 or C6 heterocycloalkylene group, Q is —CH₂—, —CH(CH₃)—, —CH═CH—, —C(═CH₂)—, —O—, —N(H)—, —S—R⁴—S—, where R⁴ is a C5 heteroarylene group or phenylene, and each of m and n is independently 0 or 1;
(e) W is an arylene group, a substituted arylene group, a heteroarylene group or a substituted heteroarylene group, and each of m and n is independently from 1 to 10;
(f) W is a group having the structure —R⁵-Q-R⁵—, where R⁵ is an arylene group or a heteroarylene group, Q is —CH₂—, —CH(CH₃)—, —CH═CH—, —C(═CH₂)—, —O—, —N(H)—, —S—R⁴—S—, where R⁴ is a C5 heteroarylene group or phenylene, and each of m and n is independently from 1 to 10; or
(g) W is a group having the structure —N(R⁶)—, wherein R⁶ is —(CH₂)ₜ—NH₂, where t is 2 or 3, and each of m and n is independently from 1 to 10; and
where when m is from 1 to 10, up to 3 in every 10 carbon atoms in the —(CH₂)ₘ— group is a heteroatom and when n is from 1 to 10, up to 3 in every 10 carbon atoms in the —(CH₂)ₙ— group is a heteroatom.

Each of R¹ and R² is independently hydrogen or a C1 to C4 hydrocarbyl group, such as C1 to C4 alkyl group, for example, methyl, isopropyl or tert-butyl. R¹ and R² can be the same or different. In one embodiment, each of R¹ and R² is H. In one embodiment, one of R¹ and R² is H and the other is a C1 to C4 hydrocarbyl group. In one embodiment, each of R¹ and R² is, independently, a C1 to C4 hydrocarbyl group.

In formula (I), each of m and n is independently 0, or from 1 to 10. When present, each of the —(CH₂)ₘ— and —(CH₂)ₙ— groups independently comprises up 3 heteroatoms for every 10 carbon atoms, i.e. up to 3 carbon atoms are replaced by a heteroatom. In other words, 0, 1, 2, or 3 carbon atoms of each of the —(CH₂)ₘ— and —(CH₂)ₙ— groups are replaced by a heteroatom. Thus: when m is 10, the group —(CH₂)ₘ— can have up to three (0, 1, 2 or 3) carbon atoms replaced by a heteroatom; when m is 7, 8 or 9, the group —(CH₂)ₘ— can have up to two (0, 1 or 2) carbon atoms replaced by a heteroatom; and when m is 4, 5 or 6, the group —(CH₂)ₘ— can have one carbon atom replaced by a heteroatom. The number of heteroatoms for the —(CH₂)ₙ— group can be worked out likewise. Alternatively, each of the —(CH₂)ₘ— and —(CH₂)ₙ— groups can independently comprise up to 2 heteroatoms for every 8 carbon atoms. Thus, when present, each of the —(CH₂)ₘ— and —(CH₂)ₙ— groups independently comprises (i) no heteroatoms; (ii) 1 to 3 heteroatoms for every 10 carbon atoms; or (iii) 2 or 3 carbon atoms for every 10 carbon atoms. The heteroatoms may be S or O or N, with any resultant valency in a heteroatom filled with a hydrogen atom.

In one embodiment of formula (I), W is a C2 to C24 alkylene group, a substituted C2 to C24 alkylene group, a C2 to C24 heteroalkylene group or a substituted C2 to C24 heteroalkylene group, each of m and n is 0, and when both of R¹ and R² are H, W has at least 6 carbon atoms. Smaller diamines will tend to cyclise, and not polymerise, when they react with the methanol. W can be: a C6 or C8 to C24 alkylene group; a substituted C6 or C8 to C24 alkylene group; a C6 or C8 to C24 heteroalkylene group; or a substituted C6 or C8 to C24 heteroalkylene group. W can be a C2, C6 or C8 to a C15 alkylene group; a substituted C2, C6 or C8 to C15 alkylene group; a C2, C6 or C8 to C15 heteroalkylene group; or a substituted C2, C6 or C8 to C15 heteroalkylene group. In particular, W can be a C6 to C12 or C15 alkylene group; a substituted C6 to C12 or C15 alkylene group; a C6 to C12 or C15 heteroalkylene group; or a substituted C6 to C12 or C15 heteroalkylene group. The alkylene groups can be chosen from hexylene, octylene, nonylene, doceylene and trideceylene. The heteroalkylene groups include alkylene groups in which from 1 to 3 carbon atoms are replaced by a heteroatom for every 10 carbon atoms, or alkylene groups in which 1 or 2 carbon atoms are replaced by a heteroatom for every 10 carbon atoms. The heteroatoms may be S or 0 or N, with any resultant valency in a heteroatom filled with a hydrogen atom. Examples of amine compounds of formula (I) include 1,6-diaminohexane, 1,8-diaminooctane, nonane-1,9-diamine, 1,12-diaminododecane, 3,6,9-trioxa-1,11-undecanediamine, diphenylethane, (1S,2S)-1,2-di-1-napthylethylenediamine, 4,9-dioxa-1,12-dodecanediamine and 4,7,10-trioxa-1,13-tridecanediamine. Also included is substituted (1R,2R)-1,2-diphenylethylenediamine:

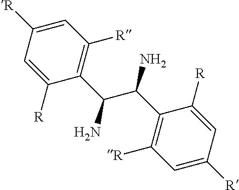

where each of R, R′ and R″ is independently H, Cl, OCH₃, CH₃, F, NMe₂ or NO₂. Also included in formula (I) are heteroakylene-based amine compounds with the following structures:

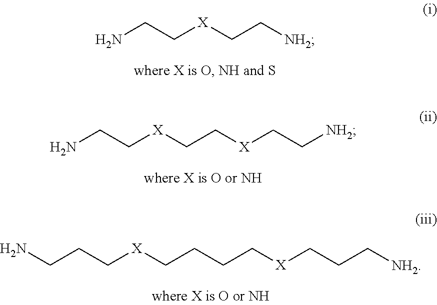

An alternative definition for heteroalkylene-based amine compounds is provided later.

In an embodiment of formula (I), W is a divalent fatty acid dimer radical and each of m and n is 0. In this embodiment, the amine compound of formula (I) is a fatty acid dimer diamine. Thus the invention includes a process for preparing polyurea by dehydrogenative coupling of an amine compound and methanol using a metal (e.g. ruthenium) pincer catalyst as described herein, where the amine compound is a fatty acid dimer diamine. Fatty acid dimer diamines are prepared commercially from fatty acid dimer diacids. Fatty acid dimer diacids can be produced from dimerisation of stearic acid, vegetable oleic acid or tall oil fatty acid, for example. Suitable fatty acid dimer diamines include those prepared from C32-C40 fatty acid dimer acids. Preferably the fatty acid dimer diamine is renewably sourced. Suitable fatty acid dimer diamines are sold by Croda™ under the trade name Priamine™ (e.g. Priamine™ 1071, 4073, 1074 and 1075). A preferred fatty acid dimer diamine is a C36 fatty acid dimer diamine. The fatty acid dimer amine can have one of the following structures:

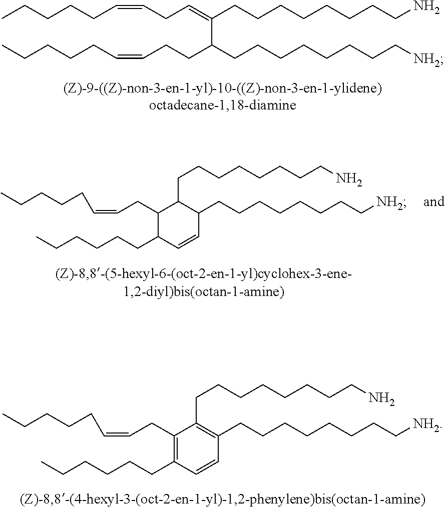 [SMILES: CCCCC/C=C\C/C=C(/CCCCCCCCN)C(CC/C=C\CCCCC)CCCCCCCCN ; CCCCC/C=C\CC1C(CCCCCC)C=CC(CCCCCCCCN)C1CCCCCCCCN ; CCCCC/C=C\Cc1c(CCCCCC)ccc(CCCCCCCCN)c1CCCCCCCCN]

In an embodiment of formula (I), W is a C5 to C13 cycloalkylene group, a substituted C5 to C13 cycloalkylene group, a C5 to C13 heterocycloalkylene group or a substituted C5 to C13 heterocycloalkylene group, and each of m and n is 0. Cycloalkylene groups include cyclopropylene, cyclobutylene, cyclopentylene, cyclohexylene, cycloheptylene, bicyclobutylene, bicyclohexylene, methylene biscyclohexyl, and tricyclobutylene. Heterocycloalklyene groups include, for example, divalent radicals of isosorbide, isoidide and isomannide. Examples of diamines of formula (I) in this embodiment include 1,2-diaminocyclohexane, 1,4-diaminocyclohexane, menthanediamine, diaminoisoidide and (3S,3aS,6S,6aS)-hexahydrofuro[3,2-b]furan-3,6-diamine.

In an embodiment of formula (I), W is a C5 to C13 cycloalkylene group, a substituted C5 to C13 cycloalkylene group, a C5 to C13 heterocycloalkylene group or a substituted C5 to C13 heterocycloalkylene group, and each of m and n is independently from 1 to 10. In this embodiment, each of m and n can independently be 1 to 6, or 1, 2, 3 or 4. m and n can be the same or can be different. Each of —(CH₂)ₘ and —(CH₂)ₙ— independently comprises (i) no heteroatoms; (ii) 1 to 3 heteroatoms for every 10 carbon atoms; or (iii) 2 or 3 carbon atoms for every 10 carbon atoms. Cycloalkylene groups include cyclopropylene, cyclobutylene, cyclopentylene, cyclohexylene, cycloheptylene, bicyclobutylene, bicyclohexylene, methylene biscyclohexyl, and tricyclobutylene. Substituted cycloalkylene groups include menthane. Heterocycloalkylene groups include divalent radicals of isosorbide, isoidide and isomannide. Examples of diamines of formula (I) in this embodiment include 3,3′-((hexahydrofuro[3,2-b]furan-3,6-diyl)bis(oxy))bis(propan-1-amine).

In an embodiment of formula (I), W has the structure —R³-Q-R³—, where R³ is a C5 or C6 cycloalkylene group, a substituted C5 or C6 cycloalkylene group or a C5 or C6 heterocycloalkylene group or substituted C5 or C6 heterocycloalkylene group, Q is —CH₂—, —CH(CH₃)—, —CH═CH—, —C(═CH₂)—, —O—, —N(H)—, —S—R⁴—S—, where R⁴ is a C5 heteroarylene group or phenylene, and each of m and n is independently 0 or 1. Preferably, each of m and n is 0. Q can be —CH₂—, —CH═CH—, or —C(═CH₂)—. Suitable C5 heteroarylene groups include divalent radicals of furan, pyrrole and thiophene. Examples of diamines of formula (I) where W has this structure include methylenedicyclohexanamine (e.g. 4,4′-methylenebis(cyclohexylamine)).

In embodiments of formula (I), W is an arylene group, a substituted arylene group, a heteroarylene group or a substituted heteroarylene group, and each of m and n is independently from 1 to 10. In these embodiments, each of m and n can independently be 1 to 6, or 1, 2, 3 or 4. m and n can be the same or can be different. Each of —(CH₂)ₘ— and —(CH₂)ₙ— independently comprises (i) no heteroatoms; (ii) 1 to 3 heteroatoms for every 10 carbon atoms; or (iii) 1 or 2 heteroatoms for every 8 carbon atoms. W can be phenylene, for example. W can be a C6 to C10 or C14 arylene group, a substituted C6 to C10 or C14 arylene group, a C5 to C10 or C14 heteroarylene group or a substituted C5 to C10 or C14 heteroarylene group. W can be a heteroarylene group chosen from furanylene, pyridylene, thiophenylene, and the divalent radical of isoidide. Examples of diamines of formula (I) in these embodiments include m-, o- and p-xylylenediamine, 2,5-Bis(aminomethyl)furan and 2,6-Bis(aminomethyl)pyridine, and diamines based on vanillin derivatives having the general formula:

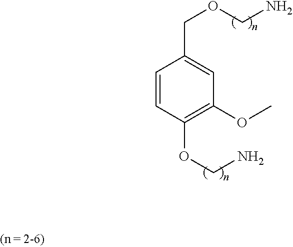

e.g., 2-((3-((4-(3-((2-aminoethyl)thio)propoxy)-3-methoxybenzyl)oxy)propyl)thio)ethan-1-amine.

In one embodiment of formula (I), W has the structure —R⁵-Q-R⁵—, where R⁵ is an arylene group or a heteroarylene group, Q is —CH₂—, —CH(CH₃)—, —CH═CH—, —C(═CH₂)—, —O—, —N(H)—, —S—R⁴—S—, where R⁴ is a C5 heteroarylene group or phenylene and each of m and n is independently from 1 to 10. In this embodiment, each of m and n can independently be 1 to 6, or 1, 2, 3 or 4. m and n can be the same or can be different. Typically, each of m and n is 1. Each of —(CH₂)ₘ and —(CH₂)ₙ— independently comprises (i) no heteroatoms; (ii) 1 to 3 heteroatoms for every 10 carbon atoms; or (iii) 1 or 2 carbon atoms for every 8 carbon atoms. W can be a C6 to C10 or C14 arylene group, a substituted C6 to C10 or C14 arylene group, a C5 to C10 or C14 heteroarylene group or a substituted C5 to C10 or C14 heteroarylene group. Q can be —CH₂—, —CH(CH₃)—, —CH═CH—, or —C(═CH₂)—. Examples of diamines of formula (I) where W has this structure include methylenedianiline and Bis(furfurylamine).

In one embodiment, W is a group having the structure —N(R⁶)—, wherein R⁶ is —(CH₂)ₜ—NH₂, where t is 2 or 3 and each of m and n is independently from 1 to 10. Thus formula (I) reads R¹HN—(CH₂)ₘ—N(R⁶)—(CH₂)ₙ—NHR². In this embodiment, preferably none of the carbon atoms in the —(CH₂)ₘ— group and/or —(CH₂)ₙ— group are replaced by a heteroatom.

In this embodiment, each of m and n can independently be 1 or 2 to 6, 2 to 4, or 1, 2, 3 or 4. Typically m and n are the same. In particular, each of m and n is the same and is 2 or 3. Examples for this embodiment include tris(2-aminoethyl)amine and tris(3-aminopropyl) amine.

An alternative structure for the heteroalkylene-based amine compounds mentioned above can be provided by formula (I), where each of m and n is independently from 1 to 10, and W is a group having the structure —[U—(CH₂)ᵥ]_{w}—U—, wherein U is 0, S or NH and where v is 2 to 4 and w is 0 to 4, i.e. w is 0, 1, 2, 3 or 4. Preferably, each of m and n is independently 2 or 3. Thus formula (I) reads R¹HN—(CH₂)ₘ—[U—(CH₂)ᵥ]_{w}—U—(CH₂)ₙ—NHR². The heteroalkylene groups can be C4 to C15 heteroalkylene groups.

In one embodiment, the amine compound is according to formula (I):

R¹HN—(CH₂)ₘ—W—(CH₂)ₙ—NHR² (I)

where each of R¹ and R² is independently H or a C1 to C4 hydrocarbyl group; and where:
(a) W is a C2 to C24 alkylene group, a substituted C2 to C24 alkylene group, a C2 to C24 heteroalkylene group or a substituted C2 to C24 heteroalkylene group, and each of m and n is 0, with the proviso that when both of R¹ and R² are H, W has at least 6 carbon atoms;
(b) W is a C5 to C13 cycloalkylene group, a substituted C5 to C13 cycloalkylene group, a C5 to C13 heterocycloalkylene group or a substituted C5 to C13 heterocycloalkylene group, and each of m and n is independently 0 or from 1 to 10;
(c) W is a group having the structure —R³-Q-R³—, where R³ is a C5 or C6 cycloalkylene group, a substituted C5 or C6 cycloalkylene group, a C5 or C6 heterocycloalkylene group or a substituted C5 or C6 heterocycloalkylene group, Q is —CH₂—, —CH(CH₃)—, —CH═CH—, —C(═CH₂)—, —O—, —N(H)—, —S—R⁴—S—, where R⁴ is a C5 heteroarylene group or phenylene, and each of m and n is independently 0 or 1;
(d) W is an arylene group, a substituted arylene group, a heteroarylene group or a substituted heteroaylene group, and each of m and n is independently from 1 to 10; or
(e) W is a group having the structure —R⁵-Q-R⁵—, where R⁵ is an arylene group or a heteroarylene group, Q is —CH₂—, —CH(CH₃)—, —CH═CH—, —C(═CH₂)—, —O—, —N(H)—, —S—R⁴—S—, where R⁴ is a C5 heteroarylene group or phenylene, and each of m and n is independently from 1 to 10; and
where when m is from 1 to 10, up to 3 in every 10 carbon atoms in the —(CH₂)ₘ— group is a heteroatom and when n is from 1 to 10, up to 3 in every 10 carbon atoms in the —(CH₂)ₙ— group is a heteroatom.

In one embodiment, the amine compound is according to formula (I):

R¹HN—(CH₂)ₘ—W—(CH₂)ₙ—NHR² (I)

where each of R¹ and R² is independently H or a C1 to C4 hydrocarbyl group; and where:
(a) W is a C6 to C15 alkylene group, a substituted C6 to C15 alkylene group, a C6 to C15 heteroalkylene group or a substituted C6 to C15 heteroalkylene group, and each of m and n is 0;
(b) W is a C5 to C12 cycloalkylene group, a substituted C5 to C12 cycloalkylene group, a C5 to C12 heterocycloalkylene group or a substituted C5 to C12 heterocycloalkylene group, and each of m and n is 0;
(c) W is a group having the structure —R³-Q-R³—, where R³ is a C5 or C6 cycloalkylene group, a substituted C5 or C6 cycloalkylene group, a C5 or C6 heterocycloalkylene group or a substituted C5 or C6 heterocycloalkylene group, Q is —CH₂—, —CH(CH₃)—, —CH═CH—, —C(═CH₂)—, —O—, —N(H)—, —S—R⁴—S—, where R⁴ is a C5 heteroarylene group or phenylene, and each of m and n is 0; or
(d) W is a C6 to C10 arylene group, a substituted C6 to C10 arylene group, a C6 to C10 heteroarylene group or a substituted C6 to C10 heteroaylene group, and each of m and n is independently from 1 to 3 and each of m and n is independently from 1 to 3, and where each of —(CH₂)ₘ— and —(CH₂)ₙ— comprises no heteroatoms.

Where an alkylene, heteroalkylene group, cycloalkylene group, heterocycloalkylene group, arylene group or heteroarylene group mentioned above in respect of the amine compound of formula (I) is optionally substituted, the substituents may be C1-10 or C1-6 alkyl, C1-C6 alkoxy (in particular C1 to C4 alkoxy, or C1 (methoxy)), halo (in particular F or Cl) or C6 to C12 aryl. Where a cycloalkylene group, heterocycloalkylene group, arylene group or heteroarylene group mentioned above in respect of the amine compound of formula (I) is optionally substituted, the substituents may be C1-10 or C1-6 alkyl, C1-C6 alkoxy (in particular C1 to C4, or C1 (methoxy)) or halo (in particular F or CI).

Suitable diamines include 1,6-diaminohexane, 1,8-diaminooctane, nonane-1,9-diamine, 1,12-diaminododecane, diphenylethane, (1S,2S)-1,2-di-1-napthylethylenediamine, 3,6,9-dioxa-1,11-undecanediamine, 4,9-diioxa-1,12-dodecanediamine and 4,7,10-trioxa-1,13-tridecanediamine, C36-C40 fatty acid dimer diamines (such as (Z)-9-((Z)-non-3-en-1-yl)-10-((Z)-non-3-en-1-ylidene)octadecane-1,18-diamine, (Z)-8,8′-(5-hexyl-6-(oct-2-en-1-yl)cyclohex-3-ene-1,2-diyl)bis(octan-1-amine) and (Z)-8,8′-(4-hexyl-3-(oct-2-en-1-yl)-1,2-phenylene)bis(octan-1-amine)), 1,2-diaminocyclohexane, 1,4-diaminocyclohexane, menthanediamine, diaminoisoidide, (3S,3aS,6S,6aS)-hexahydrofuro[3,2-b]furan-3,6-diamine, 3,3′-((hexahydrofuro[3,2-b]furan-3,6-diyl)bis(oxy))bis(propan-1-amine), methylenedicyclohexanamine, m-, o- and p-xylylenediamine, 2,5-Bis(aminomethyl)furan and 2,6-Bis(aminomethyl)pyridine, 2-((3-((4-(3-((2-aminoethyl)thio)propoxy)-3-methoxybenzyl)oxy)propyl)thio)ethan-1-amine, methylenedianiline, Bis(furfurylamine), tris(2-aminoethyl)amine and tris(3-aminopropyl) amine.

The amine compound may be chosen from the structures shown in the table below.

TABLE 1

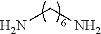

1,6-diaminohexane

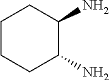

1,2-diaminocyclohexane

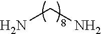

1,8-diaminooctane

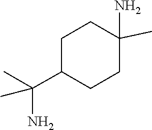

menthanediamine

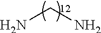

1,12-diaminododecane

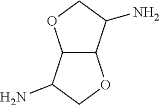

Diaminoisoidide

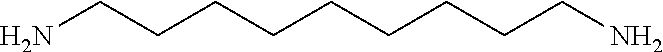 [SMILES: NCCCCCCCCCN]

nonane-1,9-diamine

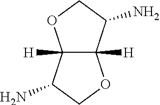

(3S,3aS,6S,6aS)-
hexahydrofuro[3,2-b]furan-3,6-
diamine

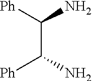 [SMILES: N[C@H](c1ccccc1)[C@H](N)c1ccccc1]

1,2-diphenylethane

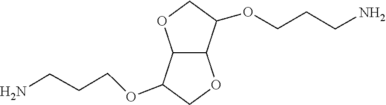 [SMILES: NCCCOC1COC2C(OCCCN)COC12]

3,3′-((hexahydrofuro[3,2-
b]furan-3,6-
diyl)bis(oxy))bis(propan-1-
amine)

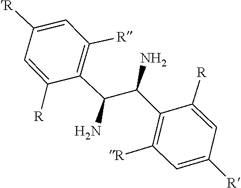

Substituted (1R,2R)-1,2-Diphenylethylenediamine
R, R′, R″ = H, Cl, OCH₃, CH₃, F, NMe₂, NO₂

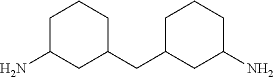 [SMILES: NC1CCCC(CC2CCCC(N)C2)C1]

methylenedicyclohexanamine

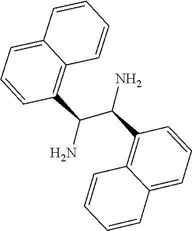 [SMILES: N[C@@H](c1cccc2ccccc12)[C@@H](N)c1cccc2ccccc12]

(1S,2S)-1,2-di-1-napthylethylenediamine

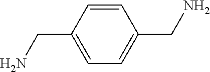

p-xylylenediamine

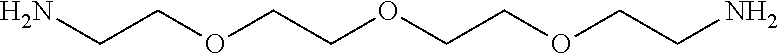 [SMILES: NCCOCCOCCOCCN]

3,6,9-trioxa-1,11-undecanediamine

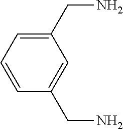

m-xylylenediamine

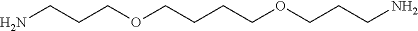 [SMILES: NCCCOCCCCOCCCN]

4,9-dioxa-1,12-dodecanediamine

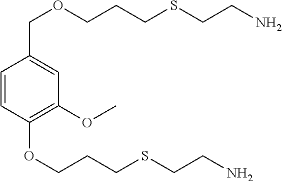 [SMILES: COc1cc(COCCCSCCN)ccc1OCCCSCCN]

2-((3-((4-(3-((2-
aminoethyl)thio)propoxy)-3-
methoxybenzyl)oxy)propyl)thio)
ethan-1-amine

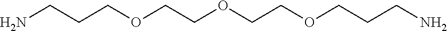 [SMILES: NCCCOCCOCCOCCCN]

4,7,10-trioxa-1,13-tridecanediamine

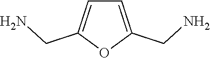

2,5-bis(aminomethyl) furan

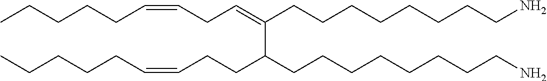 [SMILES: CCCCC/C=C\C/C=C(/CCCCCCCCN)C(CC/C=C\CCCCC)CCCCCCCCN]

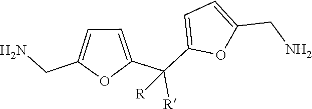

R, R′ = H, CH₃)
bis(furfurylamine)

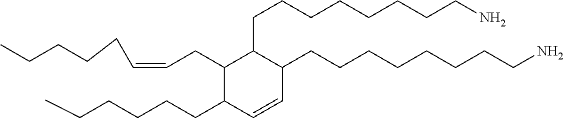 [SMILES: CCCCC/C=C\CC1C(CCCCCC)C=CC(CCCCCCCCN)C1CCCCCCCCN]

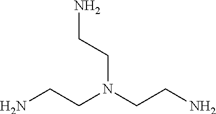

tris(2-aminoethyl)amine

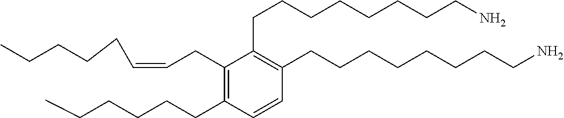 [SMILES: CCCCC/C=C\Cc1c(CCCCCC)ccc(CCCCCCCCN)c1CCCCCCCCN]

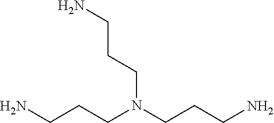 [SMILES: NCCCN(CCCN)CCCN]

tris(3-aminopropyl) amine

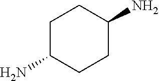

1,4-diaminocyclohexane

The amine compound can be a renewable reagent, e.g. a reagent obtained from a source that is not a fossil fuel, such as a reagent obtained from biomass, the atmosphere (e.g. CO₂ or N₂), or the recycling of plastics and other materials. The amine compound can be a renewable reagent chosen from those listed in the table below.

TABLE 2

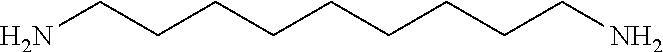 [SMILES: NCCCCCCCCCN]

nonane-1,9-diamine

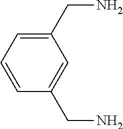

m-xylylenediamine

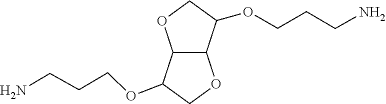 [SMILES: NCCCOC1COC2C(OCCCN)COC12]

3,3′-((hexahydrofuro[3,2-b]furan-3,6-
diyl)bis(oxy))bis(propan-1-amine)

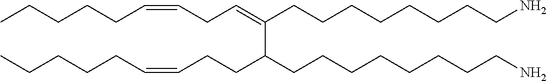 [SMILES: CCCCC/C=C\C/C=C(/CCCCCCCCN)C(CC/C=C\CCCCC)CCCCCCCCN]

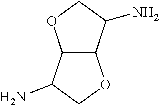

diaminoisoidide

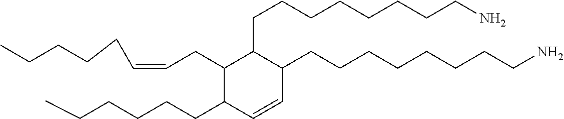 [SMILES: CCCCC/C=C\CC1C(CCCCCC)C=CC(CCCCCCCCN)C1CCCCCCCCN]

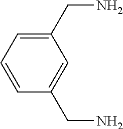

m-xylylenediamine

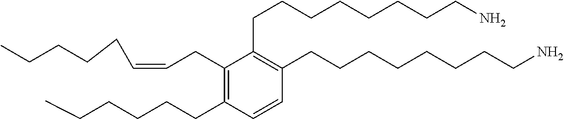 [SMILES: CCCCC/C=C\Cc1c(CCCCCC)ccc(CCCCCCCCN)c1CCCCCCCCN]

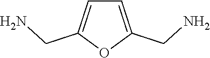

2,5-bis(aminomethyl) furan

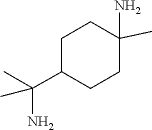

menthanediamine

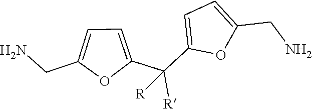

(R, R′ = H, CH₃)
bis(furfurylamine)

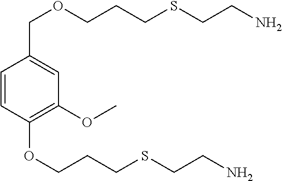 [SMILES: COc1cc(COCCCSCCN)ccc1OCCCSCCN]

2-((3-((4-((2-aminoethyl)thio)propoxy)-3-
methoxybenzyl)oxy)propyl)thio)ethan-1-amine

The amine compound can be chiral, in which case the process will produce a chiral polyurea. Suitable chiral amine compounds include those listed in the table below.

TABLE 3

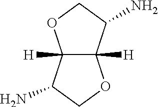

(3S,3aS,6S,6aS)-hexahydrofuro[3,2- b]furan-3,6-diamine

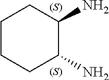

1,2-diaminocyclohexane

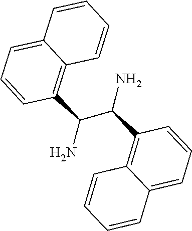 [SMILES: N[C@@H](c1cccc2ccccc12)[C@@H](N)c1cccc2ccccc12]

(1S,2S)-1,2-di-1-
napthylethylenediamine

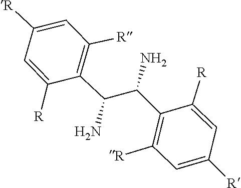

Substituted (1R,2R)-1,2-
Diphenylethylenediamine
R, R′, R″ = H, Cl, OCH₃,
CH₃, F, NMe₂, NO₂

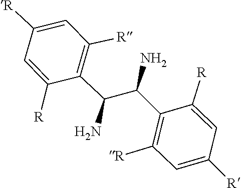

Substituted (1R,2R)-1,2-
Diphenylethylenediamine
R, R′, R″ = H, Cl, OCH₃,
CH₃, F, NMe₂, NO₂

The amine compound of formula (I) can be selected from the compounds listed in Table 4 below.

TABLE 4

| | |
|---|---|
| a | 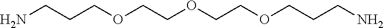 [SMILES: NCCCOCCOCCOCCCN] |
| | 4,7,10-trioxa-1,13-tridecanediamine |
| b | 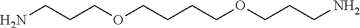 [SMILES: NCCCOCCCCOCCCN] |
| | 4,9-dioxa-1,12-dodecanediamine |
| c | 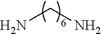 |
| | hexamethylenediamine |
| d | 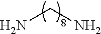 |
| | octamethylenediamine |
| e | 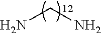 |
| | Dodecamethylenediamine |
| f | 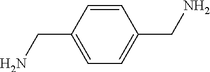 |
| | p-xylylenediamine |
| g | 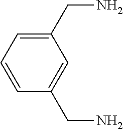 |
| | m-xylylenediamine |
| h | 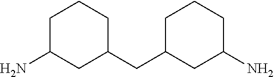 [SMILES: NC1CCCC(CC2CCCC(N)C2)C1] |
| | 3,3′-methylenedianiline |
| i | 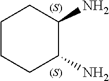 |
| | 1,2-diaminocylcohexane |
| j | 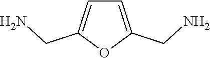 |
| | 2,5-bis(aminomethyl) furan |

### Methanol

The methanol can be a renewable reagent. Methanol can be produced from biomass or from the direct hydrogenation of CO₂. 100% renewable methanol can be produced industrially by Carbon Recycling International (https://www.carbonrecycling.is) on the scale of 50,000-100,000 tons per annum, in a method, whereby CO₂ captured from emission is catalytically hydrogenated using hydrogen gas produced from water electrolysis using renewable electricity. Advantageously, the process of the first aspect of the invention can be used to produce a renewable polyurea from the dehydrogenative coupling of methanol with an amine compound, where both reagents are renewable reagents.

The methanol can be isotopically labelled and can be, ¹³CH₃OH, for example. The process of the invention can be used to produce ¹³C-labelled polyureas by using ¹³CH₃OH. We believe that this is the first synthesis of ¹³C-labelled polyureas which may have potential applications in, for example, drug delivery, and in assessing the environmental impacts of plastics.

Advantageously, the methanol is present in molar excess of the amine compound, i.e. the molar ratio of methanol to the amine compound is greater than one. Preferably, the molar ratio of methanol to the amine compound is greater than 2, greater than 2.5, greater than 3, greater than 3.5, or is equal to or greater than 4.

### Metal Pincer Catalyst

The metal pincer catalyst is a ruthenium or manganese-based complex having a tridentate pincer ligand and has the general formula (II):

MXYZ′L (II)
where M is Ru or Mn
X is H or halo
Y is H, halo, CO, or borohydride,
Z′ is CO or PPh₃ and
L is a tridentate ligand with ANB donor sites in a meridional geometry, where each of A and B is independently chosen from P, N, O, S and N-heterocyclic carbenes.

According to certain embodiments, M is Ru.

Manganese is an earth-abundant metal, and so use of a manganese-based catalyst rather than a ruthenium-based catalyst may make the overall process more cost-effective, and sustainable. According to particular embodiments, therefore, M may be Mn.

X may be H or Br.

Y may be H, halo or borohydride.

The metal pincer catalyst may be a ruthenium pincer catalyst, which is a ruthenium-based complex having a tridentate pincer ligand and has the general formula (IIa):

RuXYZ′L (IIa)
where X is H or halo
Y is H, halo, or borohydride,
Z′ is CO or PPh₃ and
L is a tridentate ligand with ANB donor sites in a meridional geometry, where each of A and B is independently chosen from P, N, O, S and N-heterocyclic carbenes.
X of (IIa) may be H or Cl.

When M is manganese, preferably X is halo (often Br). Z′ and Y of the manganese pincer complexes are typically CO.

When M is ruthenium, preferably X is H or halo (often Cl). Y of the ruthenium pincer complexes is typically H, halo (e.g. CI) or borohydride (H—BH₃). Z′ of the ruthenium pincer complexes is typically CO or PPh₃.

L is a tridentate pincer ligand selected from a ANB type pincer type complex system.

Tridentate pincer ligands are well known in the art and are available commercially or may be synthesised according to well-known methods. They are described, for example, in the following reviews: a) Johnson, T. C et al., Chem. Soc. Rev. 2010, 39, 81. b) Dobereiner, G. E. et al., Chem. Rev. 2010, 110, 681. c) Milstein, D. Top. Catal. 2010, 53, 915.

N-heterocyclic carbene is represented by the structure:

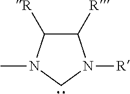

wherein each of R′, R″, and R′″ is independently selected from the group consisting of alkyl, cycloalkyl, aryl, alkylaryl, heterocyclyl and heteroaryl. For each of R′, R″, R′″ alkyl may be C1-C12, cycloalkyl may be C3 to C12, aryl may be C6 to C12.

L can have the following formula III or IV

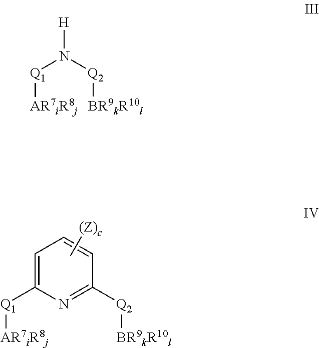

wherein each of R⁷, R⁸, R⁹ and R¹⁰ is independently chosen from hydrogen, alkyl, substituted alkyl, cycloalkyl, substituted cycloalkyl, aryl, substituted aryl, aralkyl, substituted aralkyl, alkyloxy, substituted alkyloxy, cycloalkoxy, substituted cycloalkyloxy, aryloxy, substituted aryloxy, aralkoxy, substituted aralkyloxy, heterocylic, substituted heterocyclic, amino and substituted amino groups;
wherein when A is P, i is 1, j is 1, and R⁷ and R⁸ do not join to form a ring with A; when B is P, k is 1, l is 1, and R⁹ and R¹⁰ do not join to form a ring with B; when A is O or S, i is 1, j is 0; when B is O or S, k is 1, l is 0; when A is a N-heterocyclic carbene, i is 0 and j is 0; when B is a N-heterocyclic carbene, k is 0 and l is 0; when A is N, i is 0-1, j is 0-1; and when B is N, k is 0-1, l is 0-1.
each of Q₁ and Q₂ is independently alkylene, substituted alkylene, alkenylene, substituted alkenylene, cycloalkylene, substituted cycloalkylene, benzylidene, substituted benzylidene or NH;
c is 0 or 1 to 3 and each Z is independently chosen from an alkyl, aryl, halogen, nitro, amide, ester, cyano, alkoxy, cycloalkyl, alkylaryl, heterocyclyl, heteroaryl groups, an inorganic support and a polymeric moiety. R⁷, R⁸, R⁹ and R¹⁰ may be the same or different, and/or Q₁ and Q₂ may be the same or different.

For each of R⁷, R⁸, R⁹ and R¹⁰, alkyl may be C1-C10, cycloalkyl may be C3-C8, aryl may be C6-C12, and heterocylic may be C4-C10. Each of R⁷, R⁸, R⁹ and R¹⁰ may be independently chosen from hydrogen, alkyl, substituted alkyl, cycloalkyl, substituted cycloalkyl, aryl, substituted aryl, aralkyl, substituted aralkyl, alkyoxy, substituted alkyloxy, cycloalkoxy, substituted cycloalkyloxy, aryloxy, substituted aryloxy, aralkoxy, substituted aralkyloxy, heterocylic, substituted heterocyclic, amino and substituted amino groups, where alkyl is C1-C10 alkyl, cycloalkyl is C3-C8 cycloalkyl, aryl is C6-C12 aryl, and heterocylic is C4-C10 heterocyclic.

When substituted, the substituents for each of R⁷, R⁸, R⁹ and R¹⁰, independently, may be C1-C6 alkyl or alkoxy. Each of R⁷, R⁸, R⁹ and R¹⁰ may be independently chosen from hydrogen, alkyl, substituted alkyl, cycloalkyl, substituted cycloalkyl, aryl or substituted aryl.

When A is P, each of R⁷, R⁸, R⁹ and R¹⁰ may be independently chosen from C1-C4 alkyl (such as ethyl, iso-propyl or tert-butyl), C3-C6 cycloalkyl (such as cyclohexyl) and phenyl.

When M is Ru (i.e. when the metal pincer catalyst is a ruthenium pincer catalyst) and A is P, each of R⁷, R⁸, R⁹ and R¹⁰ may be independently chosen from C1-C4 alkyl (such as ethyl or tert-butyl) and phenyl.

When M is Mn (i.e. when the metal pincer catalyst is a manganese pincer catalyst) and A is P, each of R⁷, R⁸, R⁹ and R¹⁰ may be independently chosen from C1-C4 alkyl (such as iso-propyl) and C3-C6 cycloalkyl (such as cyclohexyl).

Each of Q₁ and Q₂ can be independently C1-C2 alkylene, substituted C1-C2 alkylene, C1-C2 alkenylene, substituted C1-C2 alkenylene, C5-C10 cycloalkylene, substituted C5-C10 cycloalkylene, benzylidene, substituted benzylidene or NH.

Z can be independently chosen from a C1-C10 alkyl, C6-C12 aryl, halogen, nitro, amide, ester, cyano, alkoxy, cycloalkyl, alkylaryl, heterocyclyl, heteroaryl groups, wherein alkyl is C1-C10 alkyl, aryl is C6-C12 aryl, cycloalkyl is C2-C10 cycloalkyl, heterocyclyl is C4 to C10 heterocyclyl.

The inorganic support may be, e.g., silica, and the polymeric moiety may be, e.g., polystyrene.

The metal pincer catalyst can be represented by one of the two formulae V and VI

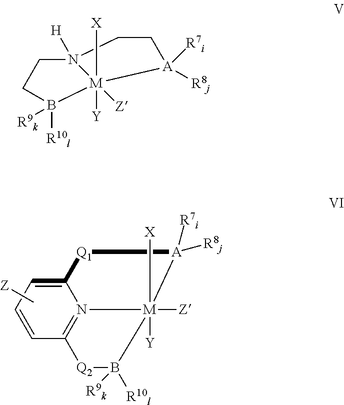

where M is ruthenium or manganese (e.g. ruthenium), Y is H, CO or halo (F, Cl, Br, I, preferably Cl) or borohydride (H—BH₃), X is H or halo, each of A and B is independently chosen from P, N, O, S, and N-heterocyclic carbenes, and Z′ is CO or PPh₃. R⁷, R⁸, R⁹, R¹⁰ and i, j, k and l in each of formulae V and VI are as defined above. Each of A and B may be, independently chosen from P, N, and S, or chosen from P and N. A and B can be the same or different. Y may be H or halo (F, Cl, Br, I, preferably Cl) or borohydride (H—BH₃). Preferably, X is H or Br, such as H. Thus each of A and B may be, independently chosen from P, N, and S, or chosen from P and N, and X may be H. When X is H, preferably Y is halo.

A and B of the metal pincer complexes are typically P.

The ruthenium pincer catalyst can be represented by one of the two formulae Va and VIa

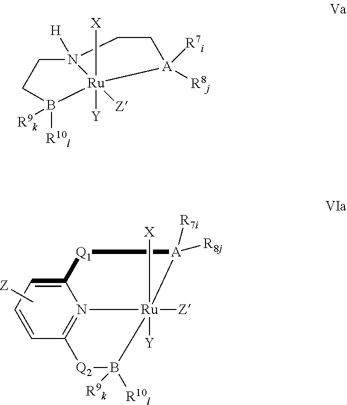

where Y is H or halogen (F, Cl, Br, I, preferably Cl) or borohydride (H—BH₃), X is H or halogen, each of A and B is independently chosen from P, N, O, S, and N-heterocyclic carbenes, and Z′ is CO or PPh₃. R⁷, R⁸, R⁹, R¹⁰, i, j, k and l in each of formulae Va and VIa are as defined above. Each of A and B may be, independently chosen from P, N, and S, or chosen from P and N. A and B can be the same or different. Preferably, X is H. Thus each of A and B may be, independently chosen from P, N, and S, or chosen from P and N, and X may be H. When X is H, preferably Y is a halogen.

The pincer catalyst can be selected from the following compounds:

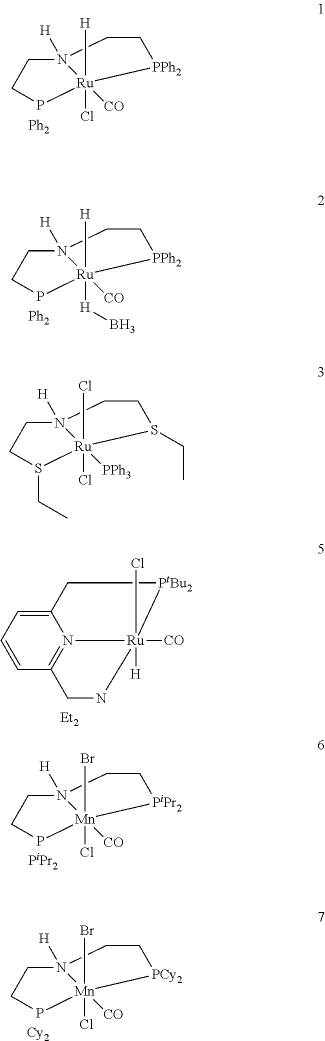

The ruthenium pincer catalyst can be selected from compounds 1, 3 and 5. Advantageously, the ruthenium pincer catalyst is compound 1.

Advantageously, the ruthenium pincer catalyst is compound 1, and the manganese pincer catalyst is compound 6.

The ruthenium pincer catalyst can be selected from the following compounds:

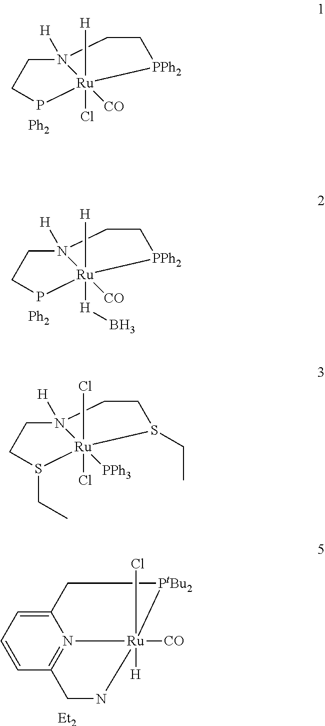

The ruthenium pincer catalyst can be selected from compounds 1, 3 and 5. Advantageously, the ruthenium pincer catalyst is compound 1.

### The Base

A base is present during the reaction. It is believed that the main role of the base is that of deprotonation of the N—H proton and removal of the chloride ligand to generate an active species (which is coordinatively unsaturated) that initiates the catalysis. A secondary role of the base could be to facilitate the release of H₂ from the metal centre (ACS Catal. 2018, 8 (8), 6908-6913) enabling the polymerisation process.

Suitable bases are known in the art. The base can be selected from the group comprising M, MH, MOH, MOR¹⁴, M₂CO₃, and MHCO₃, where M is Li, Na, K, Cs, and M′₃PO₄ and ((CH₃)₃Si)₂NM′, where M′ is Li, Na or K; and R¹⁴ is a linear or branched C1 to C7 alkyl group or a substituted or unsubstituted aryl or aralkyl group. The alkyl group can be chosen from methyl, ethyl, isoporopyl and tert-butyl. e.g. Me, Et, ⁱPr, ^{t}Bu. The aryl group can be phenyl, and the aralkyl group can be benzyl. The base can be KO^{t}Bu, NaO^{t}Bu, ((CH₃)₃Si)₂NK, KH or KOH. Preferably, the base is KO^{t}Bu.

Advantageously, the base is present in molar excess of the metal (e.g. ruthenium) pincer catalyst, i.e. the molar ratio of the base to the metal (e.g. ruthenium) pincer catalyst is greater than one. It has been found that a molar excess of base to metal (e.g. ruthenium) pincer catalyst can increase the yield of the polyurea. Preferably, the molar ratio of the base to the metal (e.g. ruthenium) pincer catalyst is greater than 2, greater than 2.5, greater than 3, greater than 3.5, or is equal to or greater than 4.

### Solvent

The process of the invention can be carried out in the absence or in the presence of a solvent. When a solvent is present it can be an organic solvent, for example, a solvent chosen from toluene, THF, 1,4-dioxane, fluorobenzene, chlorobenzene, glyme, o-xylene, m-xylene, p-xylene, methanol, diglyme, anisole, DMSO, tert-butanol, mixtures and combinations thereof, and ionic liquids. The solvent can be chosen from toluene, THF, 1,4-dioxane, glyme, o-xylene, m-xylene, p-xylene, methanol, diglyme, anisole, DMSO, mixtures and combinations thereof. Preferred solvents include toluene, THF and 1,4-dioxane. Preferred mixtures and combinations include mixtures and combinations which include at least one of toluene, THF, and 1,4-dioxane. Preferred mixtures and combinations include toluene and THF, toluene and anisole, and toluene and DMSO. Ionic liquids can be of general formula R²¹R²²R²³N⁺X⁻ (R²¹R²²R²³ can be alkyl or cyclic groups or can together form a part of 5-7 membered ring: X can be halide e.g. F, Cl, Br, I or PF₆).

The choice of solvent can affect molecular weight. Advantageously, if THF is used rather than toluene, a higher molecular weight polyurea can be formed.

The process of the first aspect of the invention involves reacting an amine compound and methanol in the presence of a metal (e.g. ruthenium) pincer catalyst and a base to form a polyurea and hydrogen gas. The process is carried out by heating a reaction mixture comprising the amine compound, methanol, a base and, optionally, a solvent to a temperature of from 110 to 150° C. The optimum temperature has been found to around 130° C. The process works better when it is carried out under a sealed system system in comparison to a system that is open to the nitrogen flow due to loss of methanol at high temperature. At high temperature, it is expected that a pressure of 1-4 bar is generated. However, pressure is not required to perform the reaction and the reaction should work better under a setting where hydrogen gas but not methanol is continuously released from the system. The reaction can take from 16 to 24 hours, for example, but this depends on factors such as the temperature and the concentration of the reagents. The polyurea product is formed as an oil phase or a solid and is isolated from the reaction mixture using appropriate methods. For example, a solid polyurea product can be isolated from the reaction mixture by filtration and can be subsequently washed and dried. An oil phase polyurea can be solidified by cooling the reaction mixture and then the solidified polyurea can be isolated from the reaction mixture by filtration and can be subsequently washed and dried.

The process of the invention can be used to produce polyureas having a number average molecular weight of, for example, from 900 to 6000 (see the worked examples). Higher number average molecular weights, e.g. up to 12000 can be obtained with the higher molecular weight diamines.

The process of the first aspect of the invention can be used to produce a chiral polyurea. Chiral polyurea can be prepared by using a chiral diamine in the process of the first aspect of the invention. Suitable chiral diamines are listed in Table 3 above and include (1R,2R)-(+)-1,2-Diphenylethylenediamine. The invention extends to a chiral polyurea obtainable/obtained by the method of the invention.

The process of the first aspect of the invention can be used to produce an isotopically labelled polyurea. This is achieved by using ¹³C-labelled methanol. ¹³C-labelled polyureas have potential applications in drug delivery to study the fate of a drug carrier (Rocas, P. et al., On the Importance of Polyurethane and Polyurea Nanosystems for Future Drug Delivery. Curr. Drug Deliv. 2018, 15 (1), 37-43.), as a ¹³C-MRI tracer (Yamada, H. et al., Magnetic Resonance Imaging of Tumor with a Self-Traceable Phosphorylcholine Polymer. J. Am. Chem. Soc. 2015, 137 (2), 799-806), and to assess environmental impact of polyureas (Sander, M. et al., Assessing the Environmental Transformation of Nanoplastic through 13C-Labelled Polymers. Nat. Nanotechnol. 2019, 14, 301-303.). The invention extends to a ¹³C-labelled polyurea obtainable/obtained by the method of the first aspect of the invention.

In another aspect, the invention provides a method for hydrogenative depolymerisation of a polyurea, wherein the polyurea is obtainable by the process of the first aspect of the invention and wherein the process comprises reacting the polyurea with H₂ in the presence of a metal (e.g. ruthenium) pincer catalyst and a base to form an amine compound and methanol. This process utilises the catalysts and base as described above for the first aspect of the invention. The amine compound will be a compound of formula (I) given above. This process uses the same solvents as those used for the first aspect of the invention except toluene, o-xylene, m-xylene, and p-xylene. In this aspect of the invention, preferably, in the amine compound of formula (I), each of m and n is 0, and W is a C6 to C24 alkylene group, a substituted C6 to C24 alkylene group, a C6 to C24 heteroalkylene group, or a substituted C6 to C24 heteroalkylene group. W can be a C6 or C8 to a C15 alkylene group; a substituted C6 or C8 to C15 alkylene group; a C6 or to C15 heteroalkylene group; or a substituted C6 or C8 to C15 heteroalkylene group. In particular, W can be a C6 to C15 heteroalkylene group or a substituted C6 to C15 heteroalkylene group. More particularly W can be a heteroalkylene group such as a C13 heteroalkylene group, or a substituted heteroalkylene group. The heteroalkylene groups include alkylene groups in which from 1 to 3 carbon atoms are replaced by a heteroatom for every 10 carbon atoms, or alkylene groups in which 1 or 2 carbon atoms are replaced by a heteroatom for every 10 carbon atoms. The heteroatoms may be S or O or N, with any resultant valency in a heteroatom filled with a hydrogen atom. Examples of such amine compounds of formula (I) include 3,6,9-tioxa-1,11-undecanediamine, 4,9-diioxa-1,12-dodecanediamine and 4,7,10-trioxa-1,13-tridecanediamine.

### Definitions

The following definitions apply herein, unless a context dictates to the contrary.

The term “comprising” is intended also to encompass as alternative embodiments “consisting essentially of” and “consisting of.” “Consisting essentially of” permits the inclusion of substances that do not materially affect the basic and novel characteristics of the composition under consideration.

As used herein, the term hydrocarbyl or hydrocarbyl group refers to a monovalent radical that has been formed by removing a hydrogen atom from a hydrocarbon group and, as a result, has a carbon atom which directly attaches to the remainder of the molecule. Hydrocarbon groups include aliphatic (e.g. alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring). By hydrocarbylene is meant divalent radical formed by removing one hydrogen atom from a hydrocarbyl group.

By heterohydrocarbyl is meant hydrocarbyl in which one or more of the carbon atoms are replaced with heteroatoms (that may be the same or different), such as oxygen, nitrogen or sulphur. Analogously, by heterohydrocarbylene is meant hydrocarbylene in which one or more of the carbon atoms are replaced with heteroatoms (that may be the same or different), such as oxygen, nitrogen or sulphur.

By alkyl is meant a saturated hydrocarbyl radical, which may be straight-chain or branched. By alkylene is meant an alkyl group from which a hydrogen atom has been formally abstracted. Typically, alkyl and alkylene groups will comprise from 1 to 25 carbon atoms, more usually 1 to 10 carbon atoms, more usually still 1 to 6 carbon atoms. Thus, for example, “alkyl” can mean methyl, ethyl, propyl, isopropyl, butyl, isobutyl, tert-butyl, pentyl or hexyl. The simplest alkylene group is methylene (—CH₂—).

By alkenyl is meant a unsaturated hydrocarbyl radical, which has one carbon-carbon double bond and may be straight-chain or branched. By alkenylene is meant an alkenyl group from which a hydrogen atom has been formally abstracted.

By heteroalkyl is meant alkyl in which one or more of the carbon atoms are replaced with heteroatoms (that may be the same or different), such as oxygen, nitrogen or sulphur. Analogously, by heteroalkylene is meant alkylene in which one or more of the carbon atoms are replaced with heteroatoms (that may be the same or different), such as oxygen, nitrogen or sulphur.

By alicyclic is meant a saturated or unsaturated aliphatic monocyclic or polycyclic hydrocarbyl radical.

By cycloalkyl is meant a saturated monocyclic or polycyclic hydrocarbyl radical. By cycloalkylene is meant a cycloalkyl group from which a hydrogen atom has been formally abstracted. Typically cycloalkyl groups and cycloalkylene groups will comprise from 3 or 5 to 12 carbon atoms. Cycloalkyl groups include polycycloalkyl groups such as those having a bicyclic structure. The term cycloalkyl is further exemplified by radicals such as cyclopropyl, cyclobutyl, cyclopentyl, cyclohexyl, cycloheptyl, bicyclobutyl, bicyclohexyl, bicycloheptyl, bicyclooctyl, bicyclononyl, tricyclobutyl. Cycloalkylene groups include polycycloalkylene groups such as those having a bicyclic structure.

By heterocycloalkyl is meant cycloalkyl in which one or more of the carbon atoms are replaced with heteroatoms (that may be the same or different), such as oxygen, nitrogen or sulphur. By heterocycloalkylene is meant a heterocycloalkyl group from which a hydrogen atom has been formally abstracted.

Aromatic moieties may be monocyclic or polycyclic, i.e. comprising two or more fused (carbocyclic) aromatic rings. Typically, aryl groups will comprise 6 to 12 carbon atoms. The simplest aryl group is phenyl. Naphthalene and anthracene are examples of polycyclic aromatic moieties.

Heteroaromatic moieties are aromatic, heterocyclic moieties, which comprise one or more heteroatoms, typically oxygen, nitrogen or sulfur, often nitrogen, in place of one or more ring carbon atoms and any hydrogen atoms attached thereto, in a corresponding aromatic moiety. Heteroaromatic moieties can be 5- or 6-membered rings and, for example, include pyridine, furan, pyrrole and pyrimidine. Benzimidazole is an example of a polycyclic heteroaromatic moiety.

Aryl radicals and arylene diradicals are formed formally by abstraction of one and two hydrogen atoms respectively from an aromatic moiety. Thus, phenyl and phenylene are the aryl radical and arylene diradical corresponding to benzene. Heteroaryl moieties are a subset of aryl moieties that comprise one or more heteroatoms (that may be the same or different), such as oxygen, nitrogen or sulphur, in place of one or more carbon atoms. Examples of suitable heteroaryl groups include thienyl, furanyl, pyrrolyl, pyridinyl, oxazolyl, thiazolyl, imidazolyl, pyrazolyl, isoxazolyl, isothiazolyl, oxadiazolyl, triazolyl, tetrazolyl, thiadiazolyl etc. Heteroarylene moieties are a subset of aryl moieties that comprise one or more heteroatoms (that may be the same or different), such as oxygen, nitrogen or sulphur, in place of one or more carbon atoms. Pyridyl and pyridylene (synonymous with pyridindiyl) are the heteroaryl radical and heteroarylene diradical corresponding to pyridine.

By arylalkyl is meant aryl-substituted alkyl. Analogously, by cycloakyl-alkyl is meant cycloakyl-substituted alkyl, by hydroxyalkyl is meant hydroxy-substituted alkyl and so on.

By alkoxy is meant —OR where R is an alkyl group.

By aryloxy is meant —OR, where R is aryl.

By heteroarylaryloxy is meant —OR, where R is heteroaryl.

Where an alkyl, cycloalkyl, aryl, heteroaryl, heterocycloalkyl group is optionally substituted, this may be, unless a context expressly dictates otherwise, with one or more substituents independently selected from halo, hydroxyl, ester, nitro, cyano, haloalkyl, sulfonyl and carbonyl groups.

By halo is meant chloro, fluoro, bromo or iodo and preferably, chloro, fluoro or bromo.

By ester is meant a —OC(O)R substituent where R is selected from alkyl, aryl, aralkyl optionally substituted.

By haloalkyl is meant an alkyl group substituted with one or more halo substituents.

By sulfonyl is meant —S(═O)₂—R where R is a substituent such a hydrogen or an alkyl group or an aryl group.

By carbonyl is meant —C(O)R where R is a substituent such a hydrogen or an alkyl group or an aryl group.

The invention is further described by way of the following non-limiting examples, and with reference to the following figures wherein:

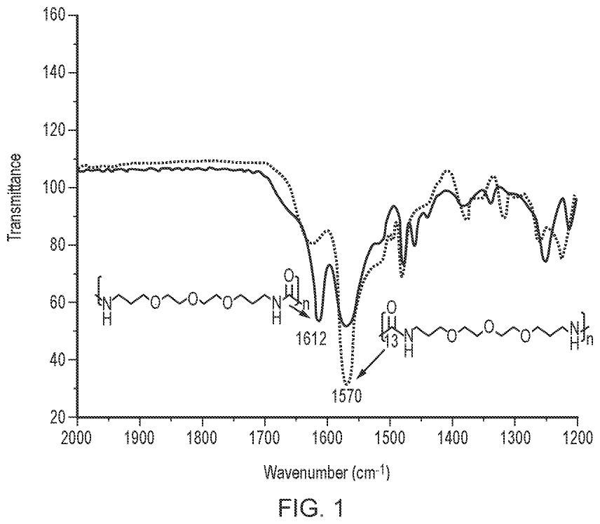

FIG. 1 shows IR spectra (1200-2000 cm⁻¹ region) showing carbonyl stretching frequency of the ¹³C-labelled and the unlabelled polyurea referred to in Experiment 3.

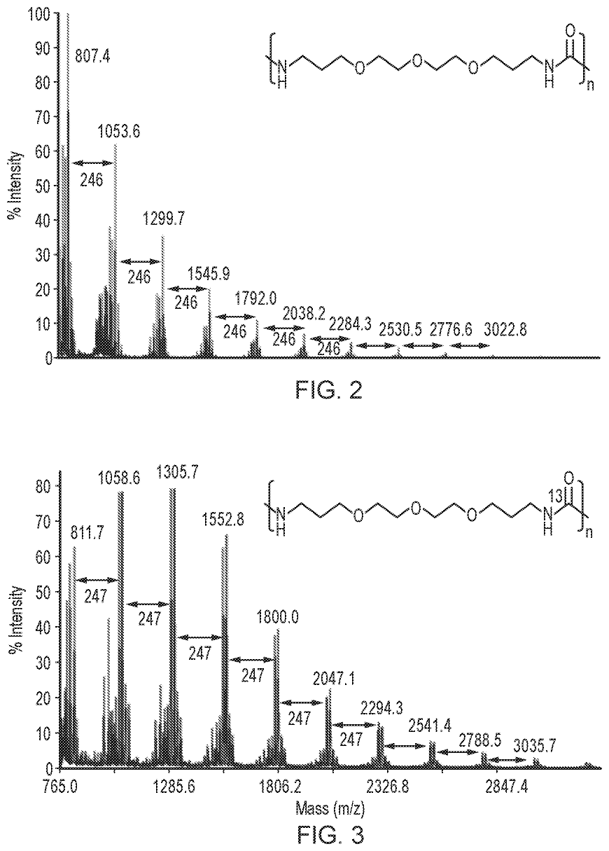

FIG. 2 shows the MALDI-TOF mass spectra for the unlabelled polyurea referred to in Experiment 3.

FIG. 3 MALDI-TOF mass spectra for the ¹³C-labelled polyurea referred to in Experiment 3.

### EXPERIMENTS

All experiments were carried out under inert atmosphere of purified nitrogen using standard Schlenk techniques unless specified. Diamines, anhydrous methanol, and complexes 1-5:

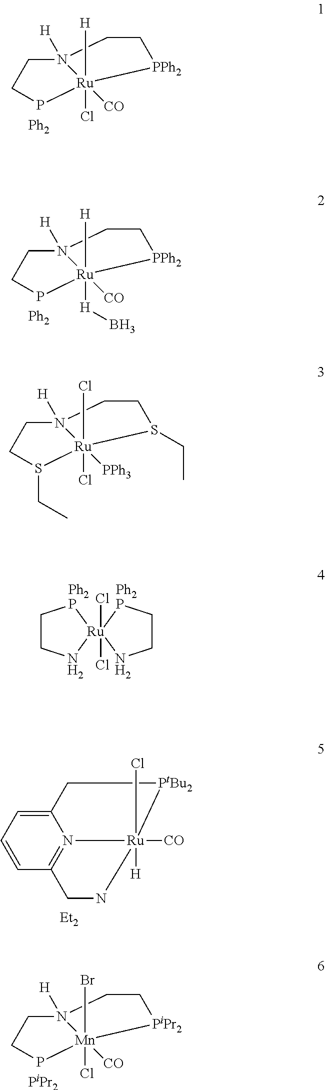

were purchased from Sigma-Aldrich, Alfa Aesar, Strem or TCl and used as received. Complexes 6, and 7 were made according to the methods reported in the literature (Gauvin, ACS Catal. 2017, 7, 2022-2032). Tetrahydrofuran (THF) and toluene were dried using solvent purification system and degassed by Freeze-Pump-Thaw under nitrogen. Anhydrous anisole and DMSO were purchased from Sigma-Aldrich and used as received. ¹³CH3OH was purchased from the Sigma-Aldrich and degassed by bubbling nitrogen gas before use. Deuterated solvents—CDCl₃ and d-TFA were purchased from the Sigma-Aldrich and used as received.

Matrix assisted laser desorption ionization-time of flight (MALDI-TOF) mass spectrometry data were acquired using a 4800 MALDI TOF/TOF Analyser (Sciex) equipped with a Nd:YAG 355 nm laser and calibrated using a mixture of peptides. For the preparation of the MALDI samples, polyureas were dissolved in neat TFA and further diluted with 0.1% TFA. 0.5 uL of the resulting solution was applied to a stainless steel MALDI target plate, 0.5 uL of matrix was co-spotted and allowed to dry. Matrix was either 2,5-dihydroxybenzoic acid or alpha-cyano-4-hydroxycinnamic acid prepared at 10 mg/mL in 50:50 acetonitrile: 0.1% TFA. MALDI data was acquired using a 4800 MALDI TOF/TOF Analyser (Sciex) equipped with a Nd:YAG 355 nm laser. The sample was acquired in positive MS mode between 200 m/z and 4000 m/z in reflector mode or 3000 m/z-10000 m/z in linear mode. The instrument was externally calibration in reflector mode using Sciex 6 peptide TOF/TOF calibration mix, and in linear mode with ubiquitin protein.

¹H, and ¹³C{1H} NMR experiments were carried out at 298 K using either a Bruker Avance II 400 (400 MHz 1H, 100 MHz ¹³C) or a Bruker Ultrashield 500 (500 MHz ¹H, 125 MHz 13C).

Gas chromatography (GC) was carried out on HP 6890/5973 (MS detector) instruments equipped with a 30 m column (Restek 5MS, 0.32 mm internal diameter) with a 5% phenylmethylsilicone coating (0.25 mm) and helium as carrier gas.

IR spectroscopy was recorded using a MIRacle™ single reflection horizontal ATR accessory from Pike (ZnSe single crystal) to analyze neat compounds.

Optical rotation measurements were taken on a Perkin Elmer 341 polarimeter using a 1 mL cell with a 1 dm path length at 20° C. using the Sodium D-line.

Thermal gravimetric analysis (TGA) was carried out using a Stanton Redcroft STA780 with a heating rate of 10° C./min from 50 to 500° C. in a N₂ flow. Differential scanning calorimetry of the polyureas were measured on a Netzsch DSC204F1 with a heating and cooling rate of 10° C./min between −100 and 400° C. in a N₂ atmosphere. All measurements were taken from the second cooling/heating segments, to eliminate thermal history events of the polyureas.

### Experiment 1—Dehydrogenative Coupling of 4,7,10-Trioxa-1,13-Tridecanediamine with Methanol

The reaction carried out in this experiment is illustrated below:

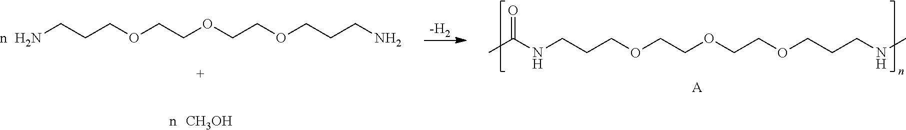

The following is the procedure used for Examples 1 to 9 and Reference Example 1. Ruthenium complex (0.02 mmol), KO^{t}Bu (amount indicated below), and 4,7,10-trioxa-1,13-tridecanediamine (440 mg, 2 mmol) were weighed (under air) in a Young's flask containing a stirrer bar and then degassed using three vacuum/nitrogen cycles in a Schlenk line. The ruthenium complex used for each example is indicated in Table below. In each of Examples 1 and 5 to 10, 0.04 mmol (4.5 mg) of KO^{t}Bu was used. In each of Examples 2 and 3, 0.02 mmol of KO^{t}Bu was used. In Example 4, no KO^{t}Bu was used. Methanol (0.32 mL, 8 mmol) was added to the Young's flask followed by the addition of a solvent (2 mL), both under nitrogen. The solvent used for each example is indicated in Table. The resulting reaction mixture was refluxed by placing the Young's flask in an oil bath at 130° C. After completion of the reaction time (24 hours), the reaction mixture was cooled to room temperature which resulted in the formation of an oily layer. The reaction mixture was then kept in a freezer at −30° C. for 30 minutes which resulted in the formation of a white precipitate. The solution was decanted off and the precipitate was washed off with pentane, and toluene and dried under vacuum to obtain a white solid characterized to be a polyurea.

TABLE 5

| | Catalyst | | | |
|---|---|---|---|---|
| | (complex) | Solvent | Yield | Mₙ |
| Example 1 | 1 | toluene | 95% | 4100 |
| Example 2 | 1 | toluene | 55% | 2100 |
| Example 3 | 2 | toluene | 32% | 1500 |
| Example 4 | 2 | toluene | 10% | — |
| Example 5 | 3 | toluene | 8% | — |
| Reference Example 1 | 4 | toluene | 0% | — |
| Example 6 | 5 | toluene | 24% | 900 |
| Example 7 | 1 | anisole | 15% | 2500 |
| Example 8 | 1 | DMSO | 25% | 1500 |
| Example 9 | 1 | THF | 85% | 4757 |

In Example 1, refluxing a toluene solution of 4,7,10-trioxa-1,13-tridecanediamine (2 mmol) and methanol (4 mmol) in the presence of complex 1 (1 mol %) and KO^{t}Bu (2 mol %) in a closed Young's flask produces a white solid which was isolated in 95% yield. The production of H₂ gas was confirmed by analysing the gas present in the headspace by the GC. An IR spectrum of the white solid showed a strong band at 1614 cm⁻¹ characteristic of a carbonyl stretching frequency. Signals corresponding to the N—H stretching and bending were observed at 3323 and 1577 cm⁻¹. These signals are in good agreement with the IR signals corresponding to a polyurea made from the reaction of CO₂ with the analogous diamine suggesting that the white solid isolated in this case is polyurea A (Jiang, S.; Shi, R.; Cheng, H.; Zhang, C.; Zhao, F. Synthesis of Polyurea from 1,6-Hexanediamine with CO2 through a Two-Step Polymerization. Green Energy Environ. 2017, 2 (4), 370-376 Jiang, S.; Cheng, H. Y.; Shi, R. H.; Wu, P. X.; Lin, W. W.; Zhang, C.; Arai, M.; Zhao, F. Y. Direct Synthesis of Polyurea Thermoplastics from CO₂ and Diamines. ACS Appl. Mater. Interfaces 2019, 11 (50), 47413-47421). This was further confirmed by a MALDI-TOF analysis that showed successive oligomeric signals corresponding to the polyurea A. ¹H and ¹³C{¹H}NMR spectra also corroborated the formation of polymer A. End group analysis by the ¹H NMR spectroscopy showed the average Mw of the polymer to be 4100.

In Example 2, using 1 mol % KO^{t}Bu (1 mol % with respect to the diamine) while keeping the remaining conditions the same as those of Example 1, resulted in a lower yield and Mw of the polymer, suggesting that the base is involved in assisting the dehydrogenation process in addition to generating the active species (by deprotonation of the N—H proton and removal of the chloride ligand in catalyst 1).

The yield for catalyst 4 is 0 (Reference Example 1) and thus this catalyst is ineffective under these reaction conditions.

Furthermore, when the reaction was performed in the presence of the Ru(PPh₃)₃HClCO, which is a precursor to the synthesis of catalyst 1, no formation of polyurea was observed. This is suggestive of the important role of the PNP pincer ligand. Changing the solvent from toluene to a more polar solvent resulted in a decrease in the yield. Very low polymer yields of 15% and 25%, were obtained in the cases of anisole and DMSO solvents, respectively (Examples 7 and 8). In the case of THF, a relatively high yield of polymer (85%) was obtained (Example 9). The molecular weight of the polymer formed in the case of THF was found to be higher than that formed using toluene. Without wishing to be bound by theory, it is believed that this is because of the high solubility of oligoureas in THF compared to that of toluene. A further example involved performing the catalysis under a neat condition in the absence of a solvent and this also resulted in a low yield (25%) of the polymer. A further example involved using a 1:1 ratio of diamine and methanol, and this resulted in a lower yield (35%) of the polyurea.

### Experiment 2—Dehydrogenative Synthesis of Polyureas

The following is the procedure used for each of Examples 9 to 18.

Ruthenium complex 1 (12 mg, 0.02 mmol), KO^{t}Bu (4.5 mg, 0.04 mmol), and diamine (2 mmol) were weighed (under air) in a Young's flask containing a stirrer bar and then degassed using three vacuum/nitrogen cycles in a Schlenk line. Methanol (0.32 mL, 8 mmol) was added to the Young's flask followed by the addition of a solvent (2 mL), both under nitrogen. The solvent used for each example is indicated in Table. The resulting reaction mixture was refluxed by placing the Young's flask in an oil bath at 130° C. for 24 hours. After completion of the reaction time, the reaction mixture was cooled to room temperature.

In the cases of polyureas formed in Examples 11 to 17, formation of an off-white (light yellow-white) precipitate was obtained whereas in the cases of the Examples 9 and 10 no precipitate was obtained but rather an oily layer separated out from the reaction mixture. In Examples 11 to 17, the light yellow-white precipitate was obtained after completion of the reaction time, by cooling the reaction flask to room temperature, filtering off the precipitate and wash the precipitate with CHCl₃, toluene and pentane. The obtained solid was dried under vacuum. In Examples, 9 and 10, in which no precipitate was obtained after completion of the reaction time, the reaction flask was cooled to room temperature which resulted in the formation of an oily layer. The reaction mixture was kept in a freezer at −30° C. for 30 minutes which resulted in the formation of a white precipitate. The solution was decanted off and the precipitate was washed off with pentane, toluene for Example 9 and with pentane, toluene and CHCl₃ for Example 10 and dried under vacuum. The polyurea formed in Example 9 is soluble in CHCl₃, and therefore CHCl₃ is not suitable for washing it.

In each case, the obtained products were analyzed by NMR and IR spectroscopy, MALDI-TOF mass spectrometry, and TGA-DSC studies.

TABLE 6

| | Amine compound | Solvent | Yield | Mol wt | Td | Tm | Tg |
|---|---|---|---|---|---|---|---|
| Example 9 | 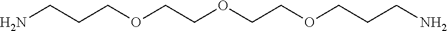 [SMILES: NCCCOCCOCCOCCCN] | THF | 85% | 4757 | 280 | NA | NA |
| Example 10 | 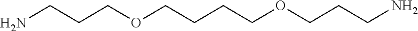 [SMILES: NCCCOCCCCOCCCN] | toluene | 80% | 5500 | 290 | 119 | NA |
| Example 11 | 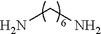 | THF | 92% | 3173 | 230 | NA | 24 |
| Example 12 | 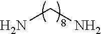 | THF | 95% | 4063 | 237 | 241 | NA |
| Example 13 | 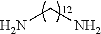 | THF | 96% | 3476 | 258 | 208 | NA |
| Example 14 | 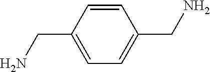 | THF | 97% | 2592 | 299 | NA | −42 |
| Example 15 | 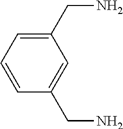 | THF | 88% | 2214 | 259 | NA | −24 |
| Example 16 | 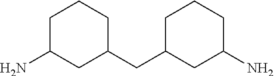 [SMILES: NC1CCCC(CC2CCCC(N)C2)C1] | THF | 86% | 4498 | 290 | NA | NA |
| Example 17 | 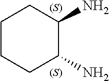 | toluene | 80% | 2862 | 289 | NA | NA |
| Example 18 | 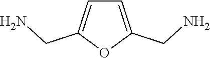 | toluene | 75% | 2763 | 230 | NA | NA |

Mol wt (Mₙ) is in Da. Values of decomposition temperature (Td), melting temperature (Tm), and glass transition temperature (Tg) are in ° C.

Except for the polyurea A (Example 9) which was soluble in H₂O, CHCl₃, DMF, and DMSO, all of the polyureas formed were either insoluble or exhibited a very poor solubility in common solvents such as toluene, CHCl₃, H₂O, THF, acetone, DMF and DMSO (<10 mg/mL). Therefore, Mw analysis by ¹H NMR spectroscopy and MALDI-TOF mass spectrometry was performed in (deuterated) trifluoroacetic acid solvent. As shown in Table 6, excellent yields of polyureas constituting the alkyl and aromatic groups were obtained in the Mw range of 2400-5500 Da. Thermal stability was studied by the thermal gravimetric analysis (TGA) and differential scanning calorimetry (DSC) measurements. Decomposition temperatures (Td) were found to be more than 300° C. in all the cases. Melting temperatures (Tm) and glass transition temperatures (Tg) were found to vary with the diamines.

In Example 17, a chiral polyurea was formed from the inexpensive, commercially available (1S,2S)-1,2-diaminocyclohexane. The polyurea was isolated in 65% yield. Its optical rotation was found to be [α]²⁰_{D}=−24.4. The sign of rotation was found to be opposite to that of the monomer whose optical rotation was found to be [α]²⁰_{D}=+20.0 (Dunjic, B.; Gamez, P.; Fache, F.; Lemaire, M. Synthesis and Characterization of a New Chiral Polyurea-Based Catalyst. J. Appl. Polym. Sci. 1996, 59 (8), 1255-1262). No optical rotation was observed in the case of the polymer made from p-xylenediamine (Example 14) confirming that chirality of the polyurea comes from the use of a chiral monomer and not because of a helical arrangement. Thus, advantageously, the method can be used produce chiral polyureas. Chiral polyureas have been utilized for optical resolution (Chiral Polyurea with L-Lysinyl Residue Aimed for Optical Resolution, Hatanaka, Journal of Membrane and Separation Technology), asymmetric catalysis (Dunjic, B.; Gamez, P.; Fache, F.; Lemaire, M. Synthesis and Characterization of a New Chiral Polyurea-Based Catalyst. J. Appl. Polym. Sci. 1996, 59 (8), 1255-1262), and recently for conformational deracemization of liquid crystals (Zoabi, A.; Santiago, M. G.; Gelman, D.; Rosenblatt, C.; Avnir, D.; Abu-Reziq, R. Chiral Polymeric Nanocapsules and Their Use for Conformational Deracemization of Liquid Crystals. J. Phys. Chem. C 2018, 122 (31), 17936-17941).

In Example 18, 2,5-Bis-(aminomethyl)furan (BAMF) was used to form the polyurea. BAMF can be synthesized by amination of 2,5-diformylfuran obtained from biomass (Delidovich, I.; Hausoul, P. J. C.; Deng, L.; Pfü, R.; Rose, M.; Palkovits, R. Alternative Monomers Based on Lignocellulose and Their Use for Polymer Production. 2015). This is an example of a renewable reactant.

The solubility of each of the polyureas formed in Examples 9 to 17 was tested by adding 10 mg of the polyurea in a vial containing 2 mL of a solvent (CHCl₃, THF, acetone, H₂O, DMF, DMSO, TFA). Polyurea corresponding to Example 9 was found to dissolve in CHCl₃, H₂O, acetone, DMF, DMSO and TFA. The polyureas of Examples 10 to 17 were found to be insoluble under these conditions in CHCl₃, THF, H₂O, DMF, DMSO, TFA. All of the polyureas were found to dissolve in TFA (trifluoracetic acid).

### Experiment 3—Dehydrogenative Synthesis of Polyureas Using Mn

The following is the reaction used in each of Examples 19 to 24.

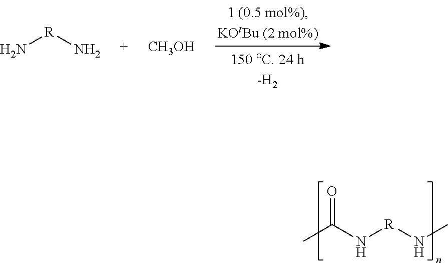

Manganese complex 6 (0.005 mmol), KOtBu (0.02 mmol), and diamine (1 mmol) were weighed (under air) in a Young's flask (volume 100 mL) containing a stirrer bar and then degassed using three vacuum/nitrogen cycles in a Schlenk line. THF (solvent) was added (1 mL) to it followed by the addition of methanol (0.16 mL, 8 mmol) both under nitrogen. The resulting reaction mixture was refluxed by placing Young's flask in an oil bath at 150° C. After completion of the reaction time (24 h), the reaction mixture was cooled to room temperature and the formed H₂ gas was released. The reaction mixture was transferred to a vial which was cooled at −30° C. where a precipitate was obtained. The precipitate was isolated by filtration and washing with hexane. The obtained product was analyzed by NMR and IR spectroscopy, MALDI-TOF mass spectrometry, and TGA-DSC studies.

Using 0.5 mol % of complex 6 and 2 mol % of KO^{t}Bu, various polyureas were synthesised from aliphatic and benzylic diamines in good to excellent yields (Table 6). Due to the insolubility of polyureas in a common organic solvent such as THF, toluene, and DMF, the molecular weight and PDI of polymers could not be estimated using GPC. Therefore, the number average molecular weights (Mn) of the isolated polymers were estimated using ¹H NMR spectroscopy. The thermal stability of the polyureas was studied using thermogravimetric analysis (TGA), which showed that the polyureas are stable up to 250 to 320° C. Decomposition temperatures (T_{d}) were calculated by 10% weight loss in the TGA experiments.

TABLE 6

| | Diamine compound | Yield | Mn | Td |
|---|---|---|---|---|
| Example 19 | 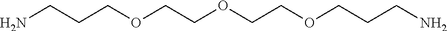 [SMILES: NCCCOCCOCCOCCCN] | 92% | 5200 | 280 |
| Example 20 | 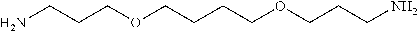 [SMILES: NCCCOCCCCOCCCN] | 85% | 6200 | 310 |
| Example 21^{a} | 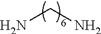 | 95% | 4500 | 250 |
| Example 22 | 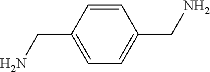 | 87% | 4200 | 310 |
| Example 23 | 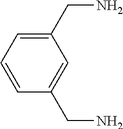 | 88% | 3400 | 278 |
| Example 24 | 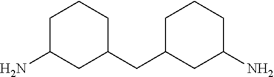 [SMILES: NC1CCCC(CC2CCCC(N)C2)C1] | 70% | 5345 | 320 |

^{a}Catalytic conditions: Diamine (1 mmol), methanol (0.16 mL, 8 mmol), Complex 6 (~3 mg, 0.005 mmol), KOtBu (~3 mg, 0.02 mmol).

### Comparison of Manganese—Over Ruthenium-Based Catalysts

The polyureas produced using manganese catalysts have similar properties (molecular weight, thermal stability) as those made using ruthenium catalysts.
The TON exhibited by the manganese catalysts is unexpectedly higher (200-1000) than that exhibited by the ruthenium catalysts (100). This means that the manganese catalysts are surprisingly more active and efficient than the ruthenium catalysts. Manganese is in general less expensive than ruthenium, the overall process with the manganese catalysts is more cost-effective.

### Experiment 4—Dehydrogenative Synthesis of Isotopically Labelled Polyurea

Using 4,7,10-trioxa-1,13-tridecanediamine and ¹³CH₃OH under the conditions described for Example 9, ¹³C-labelled polyurea ¹³C-A was synthesised in 92% yield. The carbonyl frequency in the IR spectrum of ¹³C-A was found to decrease by 42 cm⁻¹ in comparison to that of A confirming the ¹³C-labelling of the carbonyl carbon (FIG. 1). The isotope labelling was further confirmed by the MALDI-TOF mass spectrometry which showed a repetitive mass difference of 247 Da (FIG. 3), 1 Da lower than that of the unlabelled polymer A (FIG. 2), and by ¹³C{¹H}NMR spectroscopy. We believe that this the first example of a ¹³C-labelled polyurea. Polyureas have potential applications as drug carriers (Rocas, P.; Cusco, C.; Rocas, J.; Albericio, F. On the Importance of Polyurethane and Polyurea Nanosystems for Future Drug Delivery. Curr. Drug Deliv. 2018, 15 (1)) for drug delivery, and a labeled polymer can offer a new tool to study the fate of such drug carriers (Schellekens, R. C. A.; Stellaard, F.; Woerdenbag, H. J.; Frijlink, H. W.; Kosterink, J. G. W. Applications of Stable Isotopes in Clinical Pharmacology. British Journal of Clinical Pharmacology. Wiley-Blackwell December 2011, pp 879-897, Plapied, L.; Duhem, N.; des Rieux, A.; Preat, V. Fate of Polymeric Nanocarriers for Oral Drug Delivery. Current Opinion in Colloid and Interface Science. Elsevier Jun. 1, 2011, pp 228-237). Moreover, ¹³C-labelled polymers have been utilized for ¹³C-MRI (Yamada, H et al., Magnetic Resonance Imaging of Tumor with a Self-Traceable Phosphorylcholine Polymer. J. Am. Chem. Soc. 2015, 137 (2), 799-806), and to study the environmental impact of microplastics (Sander, M.; Kohler, H. P. E.; McNeill, K. Assessing the Environmental Transformation of Nanoplastic through 13C-Labelled Polymers. Nature Nanotechnology. Nature Publishing Group Apr. 1, 2019, pp 301-303). Synthesis of a ¹³C-labelled polyurea from previously reported methods for preparing polyurea would be very challenging and expensive due to the unavailability of a ¹³C-labelled diisocyanate or the need for high pressure (40-110 bar) of ¹³CO₂.

### Experiment 5—Hydrogenative Depolymerisation of Polyurea

The reaction carried out in this experiment is illustrated below:

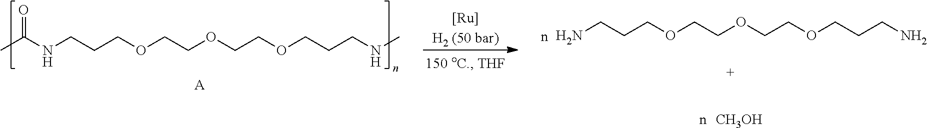

Ruthenium complex 1 (0.02 mmol), KO^{t}Bu (0.04 mmol), and polyurea A (1 mmol, weight relative to the monomer) were weighed under air and transferred to a microwave vial (5 mL) containing stirrer bar. The vial was sealed and degassed with N₂ through the septum. THF (2 mL) was transferred through a syringe to the vial. The septum was pierced with two needles and placed in a stainless-steel autoclave under N₂ atmosphere. The autoclave was sealed and degassed using H₂ gas. Upon degassing three times the autoclave was pressurised with 50 bars of H₂ gas. The autoclave was placed in a preheated oil bath at 150° C. and left for 48 h. After completion of the reaction time, the autoclave was cooled to 0° C.—room temperature in an ice-water bath, and hydrogen gas was slowly vented off. The obtained reaction mixture was analysed by the ¹H NMR spectroscopy and the GC-MS which showed the formation of methanol and diamine in 65% and 81% yields, respectively.

1. A process for preparing a polyurea by dehydrogenative coupling of an amine compound and methanol, comprising reacting an amine compound and methanol in the presence of a metal pincer catalyst and a base to form a polyurea and hydrogen gas, wherein the amine compound is of formula (I):
R¹HN—(CH₂)ₘ—W—(CH₂)ₙ—NHR² (I)
where each of R¹ and R² is independently H or a C1 to C4 hydrocarbyl group; and where:
(a) W is a C2 to C24 alkylene group, a substituted C2 to C24 alkylene group, a C2 to C24 heteroalkylene group or a substituted C2 to C24 heteroalkylene group, and each of m and n is 0, with the proviso that when both of R¹ and R² are H, W has at least 6 carbon atoms;
(b) W is a divalent fatty acid dimer radical and each of m and n is 0;
(c) W is a C5 to C13 cycloalkylene group, a substituted C5 to C13 cycloalkylene group, a C5 to C13 heterocycloalkylene group or a substituted C5 to C13 heterocycloalkylene group, and each of m and n is independently 0 or from 1 to 10;
(d) W is a group having the structure —R³-Q-R³—, where R³ is a C5 or C6 cycloalkylene group, a substituted C5 or C6 cycloalkylene group, a C5 or C6 heterocycloalkylene group, or a substituted C5 or C6 heterocycloalkylene group, Q is —CH₂—, —CH(CH₃)—, —CH═CH—, —C(═CH₂)—, —O—, —N(H)—, —S—R⁴—S—, where R⁴ is a C5 heteroarylene group or phenylene, and each of m and n is independently 0 or 1;
(e) W is an arylene group, a substituted arylene group, a heteroarylene group or a substituted heteroaylene group, and each of m and n is independently from 1 to 10;
(f) W is a group having the structure —R⁵-Q-R⁵—, where R⁵ is an arylene group or a heteroarylene group and Q is —CH₂—, —CH(CH₃)—, —CH═CH—, —C(═CH₂)—, —O—, —N(H)—, —S—R⁴—S—, where R⁴ is a C5 heteroarylene group or phenylene, and each of m and n is independently from 1 to 10; or
(g) W is a group having the structure —N(R⁶)—, wherein R⁶ is —(CH₂)ₜ—NH₂, where t is 2 or 3, and each of m and n is independently from 1 to 10; and
where when m is from 1 to 10, up to 3 in every 10 carbon atoms in the —(CH₂)ₘ— group is a heteroatom and when n is from 1 to 10, up to 3 in every 10 carbon atoms in the —(CH₂)ₙ— group is a heteroatom; and
wherein the metal pincer catalyst is a metal-based complex having a tridentate pincer ligand and has the general formula (II):
MXYZ′L (II)
where M is Ru or Mn
X is H or halo,
Y is H, halo, CO or borohydride,
Z′ is CO or PPh₃ and
L is a tridentate ligand with ANB donor sites in a meridional geometry, where each of A and
B is independently chosen from P, N, O, S and N-heterocyclic carbenes.

2. A process according to claim 1, wherein the metal pincer catalyst is a ruthenium-based complex where X is H or Cl, Y is H, halo or borohydride, and Z′ is CO or PPh₃.

3. A process according to claim 1, wherein the metal pincer catalyst is a manganese-based complex where X is H or Br, Y is H, halo or CO, and Z′ is CO.

4. A process according to claim 1, wherein the amine compound is of formula (I):
R¹HN—(CH₂)ₘ—W—(CH₂)ₙ—NHR² (I)
where each of R¹ and R² is independently H or a C1 to C4 hydrocarbyl group; and where:
(a) W is a C2 to C24 alkylene group, a substituted C2 to C24 alkylene group, a C2 to C24 heteroalkylene group or a substituted C2 to C24 heteroalkylene group, and each of m and n is 0, with the proviso that when both of R¹ and R² are H, W has at least 6 carbon atoms;
(b) W is a C5 to C13 cycloalkylene group, a substituted C5 to C13 cycloalkylene group, a C5 to C13 heterocycloalkylene group or a substituted C5 to C13 heterocycloalkylene group, and each of m and n is independently 0 or from 1 to 10;
(c) W is a group having the structure —R³-Q-R³—, where R³ is a C5 or C6 cycloalkylene group, a substituted C5 or C6 cycloalkylene group, a C5 or C6 heterocycloalkylene group or a substituted C5 or C6 heterocycloalkylene group, Q is —CH₂—, —CH(CH₃)—, —CH═CH—, —C(═CH₂)—, —O—, —N(H)—, —S—R⁴—S—, where R⁴ is a C5 heteroarylene group or phenylene, and each of m and n is independently 0 or 1;
(d) W is an arylene group, a substituted arylene group, a heteroarylene group or a substituted heteroaylene group, and each of m and n is independently from 1 to 10; or
(e) W is a group having the structure —R⁵-Q-R⁵—, where R⁵ is an arylene group or a heteroarylene group, Q is —CH₂—, —CH(CH₃)—, —CH═CH—, —C(═CH₂)—, —O—, —N(H)—, —S—R⁴—S—, where R⁴ is a C5 heteroarylene group or phenylene, and each of m and n is independently from 1 to 10; and
where when m is from 1 to 10, up to 3 in every 10 carbon atoms in the —(CH₂)ₘ— group is a heteroatom and when n is from 1 to 10, up to 3 in every 10 carbon atoms in the —(CH₂)ₙ— group is a heteroatom.

5. A process according to claim 1, wherein the amine compound is of formula (I):
R¹HN—(CH₂)ₘ—W—(CH₂)ₙ—NHR² (I)
where each of R¹ and R² is independently H or a C1 to C4 hydrocarbyl group; and where:
(a) W is a C6 to C15 alkylene group, a substituted C6 to C15 alkylene group, a C6 to C15 heteroalkylene group or a substituted C6 to C15 heteroalkylene group, and each of m and n is 0;
(b) W is a C5 to C12 cycloalkylene group, a substituted C5 to C12 cycloalkylene group, a C5 to C12 heterocycloalkylene group or a substituted C5 to C12 heterocycloalkylene group, and each of m and n is 0;
(c) W is a group having the structure —R³-Q-R³—, where R³ is a C5 or C6 cycloalkylene group, a substituted C5 or C6 cycloalkylene group, a C5 or C6 heterocycloalkylene group or a substituted C5 or C6 heterocycloalkylene group, Q is —CH₂—, —CH(CH₃)—, —CH═CH—, —C(═CH₂)—, —O—, —N(H)—, —S—R⁴—S—, where R⁴ is a C5 heteroarylene group or phenylene, and each of m and n is 0; or
(d) W is a C6 to C10 arylene group, a substituted C6 to C10 arylene group, a C6 to C10 heteroarylene group or a substituted C6 to C10 heteroaylene group, and each of m and n is independently from 1 to 3 and each of m and n is independently from 1 to 3, and where each of —(CH₂)ₘ— and —(CH₂)ₙ— comprises no heteroatoms.

6. A process according to claim 1, wherein each of R¹ and R² is H.

7. A process according to claim 1, wherein one or both of R¹ and R² is independently a C1 to C4 hydrocarbyl group.

8. A process according to claim 1, wherein the amine compound is chosen from 1,6-diaminohexane, 1,8-diaminooctane, 1,12-diaminododecane, 4,9-dioxa-1,12-dodecanediamine, 4,7,10-trioxa-1,13-tridecanediamine, 1,2-diaminocyclohexane, m-xylylenediamine, p-xylylenediamine, methylenedicyclohexanamine and 2,5-Bis(aminomethyl)furan.

9. A process according to claim 1, wherein L is of formula III or IV: 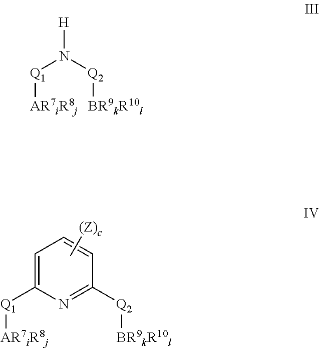
wherein each of R⁷, R⁸, R⁹ and R¹⁰ is independently chosen from hydrogen, alkyl, substituted alkyl, cycloalkyl, substituted cycloalkyl, aryl, substituted aryl, aralkyl, substituted aralkyl, alkyoxy, substituted alkyloxy, cycloalkoxy, substituted cycloalkyloxy, aryloxy, substituted aryloxy, aralkoxy, substituted aralkyloxy, heterocylic, substituted heterocyclic, amino and substituted amino groups;
wherein when A is P, i is 1, j is 1, and R⁷ and R⁸ do not join to form a ring with A; when B is P, k is 1, l is 1, and R⁹ and R¹⁰ do not join to form a ring with B; when A is O or S, i is 1, j is 0; when B is O or S, k is 1, l is 0; when A is a N-heterocyclic carbene, i is 0 and j is 0; when B is a N-heterocyclic carbene, k is 0 and 1 is 0; when A is N, i is 0-1, j is 0-1; and when B is N, k is 0-1, l is 0-1.
each of Q₁ and Q₂ is independently alkylene, substituted alkylene, alkenylene, substituted alkenylene, cycloalkylene, substituted cycloalkylene, benzylidene, substituted benzylidene or NH; and
c is 0 or 1 to 3 and each Z is independently chosen from an alkyl, aryl, halogen, nitro, amide, ester, cyano, alkoxy, cycloalkyl, alkylaryl, heterocyclyl, heteroaryl groups, an inorganic support and a polymeric moiety.

10. A process according to claim 9, wherein the metal pincer catalyst is of formula V or VI: 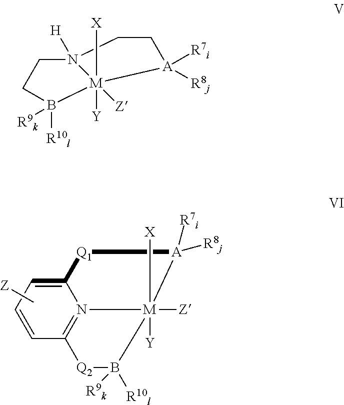
wherein R⁷, R⁸, R⁹, R¹⁰, i, j, k and l in each of formulae V and VI are as defined in claim 9.

11. A process according to claim 1, wherein the metal pincer catalyst is chosen from:

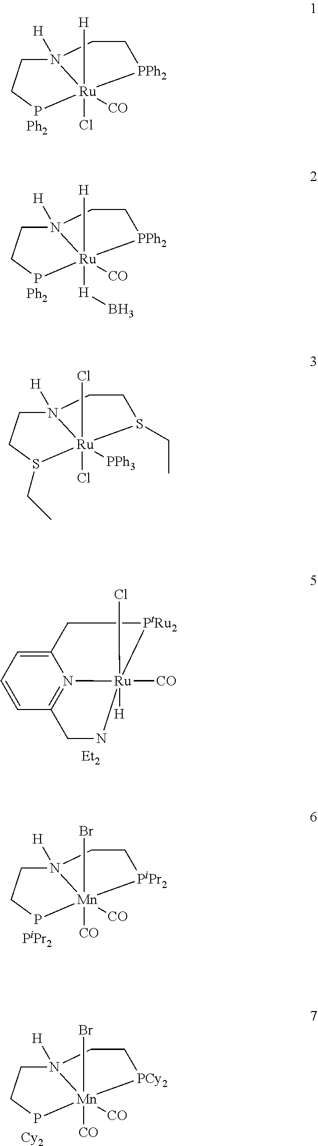

12. A process according to claim 1, wherein the methanol is present in molar excess of the amine compound.

13. A process according to claim 1, wherein the base is M, MH, MOH, MOR¹¹, M₂CO₃, MHCO₃, and ((CH₃)₃Si)₂NM, where M=Li, Na, K, Cs and R¹¹ is a linear or branched alkyl group, an aryl group or an aralkyl group.

14. A process according to claim 1, wherein the base is present in molar excess of the metal pincer catalyst.

15. A process according to claim 1, wherein a solvent is present.

16. A process according to claim 15, wherein the solvent is chosen from toluene, THF, 1,4-dioxane, fluorobenzene, chlorobenzene, glyme, o-xylene, m-xylene, p-xylene, methanol, diglyme, anisole, DMSO, tert-butanol, mixtures and combinations thereof, and ionic liquids.

17. A process according to claim 1, which comprises reacting an amine compound and methanol in the presence of a metal pincer catalyst and a base at a temperature of from 110 to 150° C.

18. A process according to claim 1, comprising a step of isolating the polyurea.

19. A process according to claim 1, wherein one or both of the amine compound and the methanol is a renewable reagent.

20. A process according to claim 1, wherein the amine compound is chiral and the process forms a chiral polyurea.

21. A process according to claim 1, wherein the methanol is isotopically labelled and the process forms an isotopically labelled polyurea.

22. A polyurea obtainable by the process of claim 20.

23. A process for hydrogenative depolymerisation of a polyurea, wherein the polyurea is obtainable by the process of claim 1; and wherein the process comprises reacting the polyurea with hydrogen in the presence of a metal pincer catalyst and a base to form an amine compound and methanol.
